(19) United States
(12) Patent Application Publication
(10) Pub. No.: US 2024/0270910 A1
(43) Pub. Date: Aug. 15, 2024

(54) POLYETHER-POLYSILOXANE BLOCK COPOLYMER-CONTAINING COMPOSITION HAVING IMPROVED FOAM ENHANCING PROPERTIES, USE THEREOF AND PRODUCTION METHOD THEREOF

(71) Applicant: DOW TORAY CO., LTD., Shinagawa-Ku, Tokyo (JP)

(72) Inventors: Seiki TAMURA, Ichihara-shi, Chiba (JP); Son Thanh PHAN, Ichihara-shi, Chiba (JP); Hiroyuki INAGAKI, Ichihara-shi, Chiba (JP)

(21) Appl. No.: 18/566,504

(22) PCT Filed: May 31, 2022
(86) PCT No.: PCT/JP2022/022116

§ 371 Date: Jan. 27, 2024

(30) Foreign Application Priority Data
Jun. 4, 2021 (JP) 2021-094166

(51) Int. Cl. C08G 77/46; C08J 9/00; C08K 5/098; C08L 75/08

(52) U.S. Cl. CPC C08G 77/46; C08J 9/0023; C08J 9/0061; C08K 5/098; C08L 75/08; C08J 2201/022; C08J 2375/08; C08J 2483/12; C08L 2203/14

(57) ABSTRACT

Provided is a composition or foam stabilizer which has sufficient quality and foam stability even when an inexpensive glycol ether compound is used as a raw material, and that has excellent foam-enhancing performance. The composition contains a specific polyether-polysiloxane block copolymer (A′) and a specific glycol ether compound (B′) at a mass ratio of (A′):(B′)=(20 to 60):(80 to 40) (wherein the total amount of (A′) and (B′) is 100. The composition further contains (K) a specific monovalent potassium salt in the range of 3 to 300 wt. ppm calculated as potassium atoms. A method for manufacturing the composition is also provided.

### TECHNICAL FIELD

The present invention relates to a polyether-polysiloxane block copolymer composition containing a polyether-polysiloxane block copolymer having a specific structure and a glycol ether compound, and that provides improved foam-enhancing properties, and to a method of manufacturing thereof. Furthermore, the present invention relates to a surfactant and foam stabilizer for polyurethane foam (including a function as a foam controlling agent and foam stabilizing agent, same hereinafter) containing this composition.

### BACKGROUND ART

A straight chain organopolysiloxane-polyether block copolymer obtained by hydrosilylation reacting (1) an organopolysiloxane containing a SiH group on both terminals and (2) a polyether containing a C═C group on both terminals is known as a nonhydrolyzable (AB)n type polyether-modified silicone (Patent Document 1, 2). These block copolymers are obtained by performing a hydrosilylation reaction in toluene solvent, but the toluene is usually removed from the product system by a stripping process under heated or reduced pressure conditions because of the toxicity and high flammability risk. Similarly, a xylene solution containing the block copolymer is known or commercialized, but similarly has a problem of including a flammable and hazardous organic solvent.

In addition to disclosing an example of a solvent exchange method where synthesis of a copolymer is performed in toluene, polypropylene glycol which is a diluting agent is added, and then the toluene is removed by a stripping operation, Patent Document 3 also describes that polyols used in a urethane foam formulation can be used as a diluting agent. Furthermore, a commercially available foam stabilizer using a long chain alkylene benzene as a reaction solvent is described as a comparative example. The solvent exchange method is advantageous for lowering the viscosity of a (AB)n type polyether-modified silicone foaming agent, improving handling, and reducing the VOC (Volatile Organic Compound) content of polyurethane foam, but there is a problem with low production efficiency due to foaming during solvent exchange. Long-chain alkylbenzenes have the advantage of simplifying the manufacturing process of foam stabilizers, but they remain in the polyurethane foam and cause high VOC, and furthermore, there is a problem with migration (bleeding) from the final product.

Patent Document 4 relates to a method for manufacturing a siloxane-polyoxyalkylene copolymer by a hydrosilylation reaction under reduced pressure, and discloses (AB)n type polyether-modified silicone compositions using IPP (isopropyl palmitate) as a reaction solvent and diluent. However, the ester oil represented by IPP has a problem of easily causing separation due to poor compatibility with the copolymer particularly at low temperature, and may cause VOC and migration from the urethane foam when contained in the foam stabilizer.

Patent Document 5 discloses technology for stably manufacturing a copolymer with a particularly high molecular weight of the nonhydrolyzable (AB)n type polyether-modified silicones or resembling structures, without causing increased viscosity, gelling, and the like. Of these, examples were shown in which the copolymer was synthesized in liquid isoparaffin and then low-boiling substances such as unreacted substances were distilled off by stripping (however, most of the liquid isoparaffin remained as a diluent for the copolymer). However, liquid isoparaffins can cause VOCs and migration from urethane foams when included in foam stabilizers.

Patent Document 6 is an invention made to solve the problems related to Documents 1 to 5, and discloses a composition containing (A) a nonhydrolyzable (AB)n type polyether-modified silicone and (B) a specific glycol ether compound in which terminal hydrogen is substituted with a hydrocarbon group having 1 to 8 carbon atoms and which has a secondary alcoholic hydroxyl group at the other terminal, a method for manufacturing the composition, a foam stabilizer containing the composition, and the like. This component (B) can be utilized as a reaction solvent and diluent for the production of component (A), and is further incorporated into the urethane resin skeleton due to the reactivity of the hydroxyl group during the formation of the urethane foam, so that there is an advantage that the minimization of the VOC of the foam and the efficient production of the foam stabilizer can both be achieved.

Patent Document 7 proposes, as a solution to the problem that hydrosilylation of a SiH-containing compound and a compound having an olefinic unsaturated group at a terminal in the presence of a chloroplatinic acid catalyst cannot be sufficiently carried out because a considerable side reaction occurs in the presence of water or alcohols, carrying out the hydrosilylation in the presence of an aqueous buffering agent solution that maintains the pH of the system at 5 to 7 even in the presence of a strong acid.

Patent Document 8 claims a process for preparing general side-chain polyether-modified silicone surfactants by a hydrosilation reaction in high-boiling-point polyols having no olefinically unsaturated groups, such as dipropylene glycol, and a mixture of the silicone surfactants and polyols, wherein the content of polyols in the mixture is at least 5 wt %, and the mixture contains at least 100 ppm of reaction accelerators, alkali or alkaline earth salts of C2 to C19 monovalent carboxylic acids. In Example 9 of this document, a solution of chloroplatinic acid in ethanol was used as the hydrosilation catalyst, and potassium acetate was used as the buffering agent at 550 ppm of the total mixture.

Patent Document 9 claims, as a surfactant composition for flexible polyurethane foams, a mixture containing 99.98 to 90 wt. % of a nonhydrolyzable side-chain polyether-modified silicone and 0.02 to 10 wt. % of an organic acid salt suitable for the same application. With this technology, the addition of the organic acid salt and the production step of the polyether-modified silicone are independent of each other, and the organic acid salt is added to the polyether-modified silicone as a solid or as an aqueous solution, and heating for reducing the water content is optional. The resulting surfactant composition is said to have improved height and breathability of the flexible polyurethane foam. In Example Additive No. 20, a mixture of side chain-type polyether-modified silicone, potassium oleate, and water in a weight ratio of 99.0:0.4:0.6 was tested.

Patent Document 10 claims a method for manufacturing a general side chain-type polyether-modified silicone by hydrosilylation with a platinum catalyst in an organic solvent, which is characterized in that a polyether-modified silicone with reduced odor is obtained by using a high-purity monoalkenyl-terminated polyether with reduced peroxide value and total carbonyl content, and which includes a water distillation step after the reaction, addition of a predetermined amount of an antioxidant, and optionally addition of a buffering agent such that the pH when dissolved in water is 5.5 to 8. With this technology, the buffering agent is added after the polyether-modified silicone has been synthesized. In

Reference Examples 1 to 4, an IPA solution of chloroplatinic acid was used as the catalyst, and a methanol solution of sodium acetate (100 wt. ppm as sodium acetate with respect to the polyether-modified silicone composition excluding the organic solvent) was used as the buffering agent.

Patent Document 11 discloses a polyorganosiloxane-polyoxyethylene block copolymer [specific (AB)n type polyether-modified silicone], a method for manufacturing the same, and a vesicle composition containing the same. In Examples 1 to 4, the (AB)n type polyether-modified silicone was prepared by performing a reaction in xylene under the presence of 484 to 688 ppm of sodium acetate using a dimethyl siloxane solution of 1,3-diethenyl-1,1,3,3-tetramethyldisiloxane platinum complex as a catalyst. In Examples 8 to 11, similar (AB)n type polyether-modified silicones were prepared by reacting with the same catalysts in the presence of 438 to 500 ppm of sodium acetate in IPA-solvent. These reaction solvents were removed by a stripping operation after completion of the reaction.

Note that Patent Document 11 discloses a large number of reaction solvents that can be used as necessary in manufacturing the (AB)n type polyether-modified silicone, and also includes aliphatic hydrocarbons such as hexane, heptane, and the like, but the disclosure is simply a non-limiting example of a selectable solvent. In addition, many of these solvents are used in the manufacturing of (AB)n type polyether-modified silicone, but there are many solvents that are not practical because they inhibit reactions, cause reaction system non-uniformity and side-reactions, and the like, and a person of ordinary skill in the art would have to perform extensive testing in order to find an optimal solvent, and the reactivity and stability of the solvent would need to be verified, and there is no specific description whatsoever about selecting an appropriate solvent. In particular, there is no description nor mention of (B) a specific glycol ether compound in which a terminal hydrogen is substituted with a hydrocarbon group having 1 to 8 carbon atoms and which has a secondary alcoholic hydroxyl group at the other terminal that can be used as a synthesis reaction solvent and diluent of an (AB)n type polyether-modified silicone having a structure suitable as a main component of a foam stabilizer for polyurethane foam, nor of improving an industrial production process of the foam stabilizer, nor of realizing and benefiting from fine cells of polyurethane foam due to good compatibility between the foam stabilizer and a premix liquid. Therefore, Patent Document 11 does not clearly teach the invention of Patent Document 6 and the technical advantages thereof to a degree that could be understood by a person of ordinary skill in the art.

Patent Document 12 disclosed a process for the production of polyether-modified silicones having an —SiOC— content of less than 1 mol %, which consists in hydrosilylating a polyether having at least one terminal unsaturated aliphatic hydrocarbon group and having an alkali content of less than 50 ppm with an organohydrogensiloxane having an acid number of less than 0.005. In all of the experimental examples, it was reported that general side chain-type polyether-modified silicone synthesis reactions were carried out under solvent-free conditions, and the addition of sodium acetate in 13 ppm (Comparative Example 4) or potassium acetate in 15 ppm (Comparative Example 5) to the reaction system resulted in a delay in the reaction speed. This technology is based on the concept that a purified raw material having a low ionic impurity content is used for both the siloxane side and the polyether side involved in hydrosilylation to continuously maintain excellent reactivity without stagnation in the course of the reaction in the reaction system, thereby realizing stable and efficient production of a polyether-modified silicone. In addition, many usable reaction solvents have been disclosed, and monoethers of propylene glycol or dipropylene glycol have also been included, but there has been no mention of the specific problems and causes that occur when these are used as synthesis solvents for (AB)n type polyether-modified silicones.

Patent Document 13 discloses a composition containing a general side chain-type polyether-modified silicone and a compound similar to (B), a method for manufacturing the composition, a foam stabilizer containing the composition, and the like. Paragraph 0084 shows that a buffering agent such as a carboxylic acid alkali metal salt can be added for the purpose of suppressing a side reaction or the like, and a plurality of options regarding the addition method. Further, it has been described that when a polar solvent is used to dissolve the salt, removal by a stripping operation can be optionally performed before the start of the main reaction or after the end of the main reaction. However, the type and method of use of the buffering agent is only a non-limiting disclosure, and no buffering agent was used in the Examples/Comparative Examples, and there was no information about the preferred amount of buffering agent component added. In addition, it is difficult to understand from Patent Document 12 that the above-mentioned specific problems are occurring when the low-priced raw material (B) is used as a synthetic solvent for the (AB)n type polyether-modified silicone (A), and therefore, no concrete and specific means has been disclosed for the best solution thereof.

As described above, in Patent Documents 1 to 13, various weakly alkaline buffering agents have been considered to be usable as additives in the production process of polyether-modified silicones by hydrosilylation, and their role or expected effect is based on the function of the buffering agent to neutralize acidic substances in the system (thereby suppressing side reactions during production=accelerating the main reaction or suppressing changes with time during storage of the product after production). In other words, the weak alkaline buffering agents in these documents are literally expressed as a plurality of buffering agents, reaction accelerators, catalyst modifiers, additives for reducing odor, and the like, but the basic function of expressing these has resulted in neutralization or pH adjustment of the system.

In other words, Patent Documents 1 to 13 neither describe nor suggest the discovery of a new function by the present inventors that, in a composition containing “(AB)n type polyether-modified silicone” and “a specific glycol ether compound in which terminal hydrogen is substituted with a hydrocarbon group having 1 to 8 carbon atoms and which has a secondary alcoholic hydroxyl group at the other terminal” as main components, when a specific potassium salt is present in a small amount that can be dissolved in the composition, specifically enhanced surface activity ability and foam retention ability are imparted to the composition.

In addition, Patent Documents 1 to 13 neither describe nor suggest about quality problems of a foam stabilizer made primarily of (A) or (A) and (B) due to the use of cheap raw material (B) when performing a synthesis reaction by hydrosilylation of
(A) (AB)n type polyether-modified silicone, using
(B) a specific glycol ether compound having a terminal hydrogen substituted by a hydrocarbon group with 1 to 8 carbon atoms and having a secondary alcoholic hydroxyl group at the other terminal as a reaction solvent. There is also no description nor suggestion of the effect of limiting the amount of specific potassium salts on the quality and production stability of foaming agents.

### RELATED ART DOCUMENTS

### Patent Documents

Patent Document 1: U.S. Pat. No. 3,957,842 (Japanese Unexamined Patent Application No. S56-22395)
Patent Document 2: U.S. Pat. No. 4,150,048
Patent Document 3: Japanese Unexamined Patent Application H08-156143
Patent Document 4: U.S. Pat. No. 5,869,727 (Japanese Unexamined Patent Application No. H11-116670)
Patent Document 5: Japanese Unexamined Patent Application 2006-282820 A (U.S. Pat. No. 4,875,314)
Patent Document 6: International Patent Application Publication WO 2016/166979 (U.S. Pat. No. 10,717,872)
Patent Document 7: U.S. Pat. No. 3,398,174
Patent Document 8: U.S. Pat. No. 4,857,583 (Japanese Unexamined Patent Application H1-87633)
Patent Document 9: U.S. Pat. No. 5,472,987 (Japanese Patent No. 2599237)
Patent Document 10: U.S. Pat. No. 5,696,192 (Japanese Unexamined Patent Application No. H9-202829)
Patent Document 11: International Patent Application Publication WO 2005/103117
Patent Document 12: U.S. Pat. No. 8,008,407 (U.S. Pat. No. 5,101,598)
Patent Document 13: International Patent Application Publication WO 2018/074257 (US20200048427A1)

### SUMMARY OF THE INVENTION

### Problem to be Solved by the Invention

On the other hand, in the present invention, the inventors have found a new problem and a solution not described in these patent documents. In recent years, in the production of microcellular foams, which is the main use of (AB)n type polyether-modified silicones, the foam retention capacity has become an important property required of the foam stabilizer. Specifically, there is a strong demand for a foam stabilizer for microcellular foams having strong foam retention because of the possibility of reducing the amount of foam stabilizer added (cost reduction) and the ease with which foams having acceptable physical properties can be obtained even when low-density foams are designed by increasing the amount of blowing agent, entrained gas, and the like (achieving energy savings by weight reduction).

A conventional method for improving foam retention is to design a foam stabilizer formulation so as to obtain a high-molecular-weight and high-viscosity product having a large n number, or in other words, to react the starting polyether and polysiloxane with a C═C/SiH molar ratio close to 1.0. However, with this method, it is known that the viscosity of the obtained foam stabilizer is greatly affected by slight measurement errors of the raw materials, variation in quality between production lots, slight differences in manufacturing conditions, and the like, and there is a problem that the frequency of manufacturing off-specification products is high. In addition, a product with high viscosity has poor productivity and handleability, and this inevitably leads to a further increase in cost. Therefore, despite the excellent performance of the (AB)n type polyether-modified silicone, it may be difficult to proliferate the (AB)n type polyether-modified silicone in the market.

Here, the technique of Patent Document 6 has provided some improvement to this complex and complicated problem, but leaves room for further improvement in terms of industrial simplicity and improvement in production efficiency. In particular, since a foam stabilizer is required to be inexpensively and industrially supplied in a large amount and stably, a foam stabilizer composition obtained by using a conventional technique requiring a high level of production control remains an unsolved problem in spreading the composition to the market.

As described above, the (AB)n type polyether-modified silicone can be designed to have an average molecular weight of a copolymer, and the surface activation performance, affinity to a urethane foam system, and the like can be controlled by the EO % or size of a polyether portion or by introducing a hydrophobic group or hydroxyl group to a terminal portion of a copolymer, and therefore an excellent effect as a surfactant for foam stabilization or foam control can be demonstrated in all polyurethane foam formulations other than high resilience foam which requires a foam stabilizer with a low molecular weight. However, conventionally known technology has the aforementioned problems with performance, production problems directly linked to industrial production cost, problems with application, and problems such as insufficient penetration into the market regardless of potential value due to these factors.

In view of the demand from the market for silicone foam stabilizers for polyurethane foams and the widespread use of high-performance silicone foam stabilizers in the market, there is a strong demand for a foam stabilizer using an (AB)n type polyether-modified silicone, a process for manufacturing the foam stabilizer, and a formulation using the foam stabilizer, which has low cost, is not susceptible to measurement errors of raw materials and the effects of lots (acid value, and the like), can be produced stably and easily, has excellent cost-in-use and availability, and has sufficient performance for use as a foam stabilizer for polyurethane foams, in particular, foamability, foam-enhancing properties, foam-controlling properties and foam stability in the foam system.

### Means for Solving the Problem

In order to solve the aforementioned problem, the present inventors have performed diligent study and found that the above problems can be solved by a composition containing (A′) a polyether-polysiloxane block copolymer having a specific structure, (B′) a specific glycol ether compound, and (K) a potassium salt having a monovalent counter anion containing only carbon, hydrogen and oxygen, having 1 to 8 carbon atoms, and not having a benzene ring structure, wherein the mass ratio of component (A′):component (B′) is in a range of 20:80 to 60:40, and the amount of potassium cation (K⁺) in component (K) is in a range of 3 to 300 wt. ppm relative to the sum of component (A′) and component (B′) (hereinafter referred to as “the present composition”), and by use of the present composition. Thereby the present invention was achieved.

More specifically, the present composition contains: (A′) a polyether-polysiloxane block copolymer having in a molecule structural units expressed by General Formula (1):

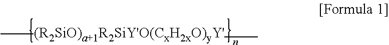

(where each R independently represents a monovalent hydrocarbon group having 1 to 9 carbon atoms without an aliphatic unsaturated bond, a is a number from 1 to 200, x represents a number from 2 to 200, a represents a number from 2 to 4, y is a number such that the molecular weight of the polyether moiety expressed by (CₓH₂ₓO)_{y} is in a range from 400 to 5000, n represents a number that is at least 2, and Y′ represents a divalent hydrocarbon group having 2 to 8 carbon atoms, which is bonded to a polyoxyalkylene block by a carbon-silicon bond of a silicon atom and an adjacent oxygen atom);
(B′) one or more type of glycol ether compound where a terminal hydrogen is substituted by a hydrocarbon group having 1 to 8 carbon atoms, a secondary alcoholic hydroxyl group is provided on another terminal, the repeating number of oxyalkylene units with 2 to 4 carbon atoms is a number within a range of 1 to 3, and heteroatoms other than oxygen are not included; and
(K) a potassium salt having a monovalent counter anion containing only carbon, hydrogen, and oxygen, having 1 to 8 carbon atoms, and not having a benzene ring structure;
where the mass ratio of Components (A′):(B′) is in a range of 20:80 to 60:40, and the amount of potassium cation (K⁺) in Component (K) is in a range of 3 to 300 wt. ppm, based on the sum of Component (A′) and Component (B′),
and optionally containing:
(S) one or more liquid compounds that are solvents of component (K) selected from (S1) water, (S2) monohydric saturated alcohols having 1 to 4 carbon atoms, and (S3) saturated diol compounds having 3 to 9 carbon atoms, and/or
(C) a polyether compound compatible with component (A′), component (B′) and component (K) and selected from specific (C1) to (C3) components.

Similarly, the above problems are solved by a surfactant, a foam stabilizer for polyurethane foam, or a premix liquid for polyurethane foam (hereinafter referred to as “surfactant or the like”) containing the present composition.

Furthermore, the above problems are also solved by a method for manufacturing the present composition, including the steps of: mixing the polyether containing an alkenyl group at both ends and component (K), which are raw materials of component (A′), in advance, and obtaining component (A′) by a hydrosilylation reaction in the presence of component (B′); or a method of manufacturing the present composition, including the steps of:
obtaining component (A′) by a hydrosilylation reaction in the presence of component (B′), and adding component (K′) after the hydrosilylation reaction. Note that either of the production methods may further include a step selected from a filtration step of the present composition, a step of adding and optional removing component (S), and a step of adding component (C).

Furthermore, the above problems are solved by a method for producing a surfactant or the like including the above production method, a composition for forming a polyurethane foam including the present composition or the present composition obtained by the above production method, and a polyurethane foam using the composition as a raw material.

### Effect of the Invention

The present invention can provide an (AB)n type polyether-modified silicone composition that has low cost, is not easily affected by lot difference and weight errors of raw materials, can be stably and easily produced, that has excellent cost-in-use and availability, and that has sufficient performance for use as a foam stabilizer for polyurethane foam, particularly foaming properties, foam-enhancing properties, foam-controlling properties, and foam stability in a foam system, and can provide a manufacturing process thereof. As a result, it is expected that a surfactant or the like (particularly, a foam stabilizer) containing a high-performance (AB)n type polyether-modified silicone as a main component can be widely proliferated in the market, which has been difficult to achieve by conventional technology.

Furthermore, it is possible to provide a surfactant or the like containing the composition and a method for producing the same. In addition, since the composition (including the composition obtained by the above-mentioned production method) is particularly useful as a foam stabilizer for polyurethane foams and has specifically enhanced surfactant capability and foam retention ability, it is possible to provide a polyurethane foam having high performance and excellent industrial productivity using the composition as a raw material.

More specifically, the present invention can provide a new polyether-polysiloxane block copolymer composition with excellent fine cell formability, foam retention, foaming capability, and foam volume, that has excellent homogeneity and stability in a premixed solution, and that has excellent compatibility with the various components in a foam-forming emulsion composition in various fields such as high-density microcellular foam using a mechanical foaming method, other hard foams and soft foams, and the like. Furthermore, a foam stabilizer for a polyurethane foam containing the composition can be provided.

Furthermore, the composition of the present invention has an excellent foam retention ability due to the use of component (K) even if the (AB)n type polyether-modified silicone foam stabilizer has a low viscosity or a not so large molecular weight, and therefore practical sufficient performance can be ensured without setting the C═C/SiH molar ratio to a condition close to 1.0 at the time of production, and thus there is an advantage that production control is easy. In addition, the production method including the hydrosilylation reaction according to the present invention has an advantage that an (AB)n type polyether-modified silicone foam stabilizer having practical sufficient performance and quality can be stably supplied to the market at low cost even if a material having large lot variation or low cost raw material having a slightly higher acid value is used as component (B′) or the like.

### DESCRIPTION OF THE PREFERRED EMBODIMENTS

A polyether-polysiloxane block copolymer composition of the present invention will be described below in detail.

### Component (A′)

Component (A′) is one of the main components of the present composition, and is a polyether-polysiloxane block copolymer having in a molecule a configuration unit expressed by General Formula (1):

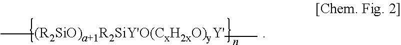

The terminal group of component (A′) is not particularly limited as long as it satisfies the above structure, but if component (A′) is synthesized by the hydrosilylation reaction described later, the structure of the molecular chain terminal is preferably one or more functional group selected from:
Z¹: alkenyl groups, hydroxyl groups, alkoxy groups, or acetoxy groups bonded to a polyether moiety;
Z²: monovalent hydrocarbon groups that do not have a hetero atom, hydroxyl groups, alkoxy groups, a C1 to C8 hydrocarbon oxyalkyleneoxy group, or hydrogen atom, bonded to a silicon atom.

In the aforementioned formula, R individually represents a monovalent hydrocarbon group with 1 to 9 carbon atoms that do not have an aliphatic unsaturated bond, and examples include alkyl groups with 1 to 9 carbon atoms. Industrially, methyl groups are particularly preferable. Y′ is a divalent hydrocarbon group having 2 to 8 carbon atoms bonded to an adjacent silicon atom via a carbon-silicon bond and bonded to a polyoxyalkylene block via an oxygen atom, preferably a divalent hydrocarbon group having 3 to 4 carbon atoms, and particularly preferably an isobutylene group.

a is a number of 1 to 200, x is a number of 2 to 4, y is a number such that the molecular mass of the polyether moiety expressed by (CₓH₂ₓO)_{y} is in a range of 400 to 5000, the polyether moiety contains at least one oxypropylene group, and n is a number that is at least 2.

From the perspective of use as a foam stabilizer and handling properties of the copolymer, a is particularly preferably a number within a range of 10 to 45, y is particularly preferably a number where the molecular weight of a polyether (polyoxyalkylene) moiety is within a range of 1500 to 5000, and the mass ratio of oxyethylene (C₂H₄O) units configuring the entire polyether moiety is particularly preferably within a range of 30 to 80% on average. In the aforementioned range, the balance of the hydrophilicity of the polyether-polysiloxane block copolymer is favorable, and a certain amount of oxypropylene units or oxybutylene units is inevitably included, and therefore, the range is advantageous for improving the compatibility between the foam stabilizer and polyol or isocyanate which is a main component of the polyurethane foam-forming composition, and for achieving increased convenience by improving the stability of a premixed solution, a desirable foam stabilizing effect, or the like. Function as a surfactant or foam stabilizer and handling properties during synthesis or after synthesis are also improved.

From the perspective of use as a foam stabilizer and stability of the copolymer, one terminal or both terminals of the polyether-polysiloxane block copolymer is preferably blocked by a functional group including a polyether portion, and in this case, the terminal group is represented by Z1, and is preferably an alkenyl group, hydroxyl group, alkoxy group, or acetoxy group bonded to a polyether moiety, and is particularly preferably a methallyl group. Note that when an organopolysiloxane containing SiH groups at both terminals is used as the starting material for component (A′), some of the terminal SiH groups may react with the hydroxyl groups of component (B′) described below, and some of the terminal groups may be glycol ether residual groups derived from component (B′).

On the other hand, the terminal group of component (A′) preferably does not include a reactive functional group having a hetero atom, and particularly preferably does not include a ring-opening reactive functional group which is an epoxy group, or an amine group, or the like.

Regarding Component (A′), the average molecular weight of the copolymer can be designed by adjusting the molar ratio (reaction ratio) between the organopolysiloxane containing a SiH group on both terminals and the polyether containing an alkenyl group on both terminals, which are raw materials. Furthermore, surface activating performance, affinity to a urethane foam system, and the like can easily be controlled based on the EO % or size of a polyether moiety, and introduction of a hydroxyl group or hydrophobic group to a copolymer terminal moiety. Therefore, the copolymer composition can be used in various types of polyurethane foam formulations with excellent effects as surfactants for foam control or foam stabilization.

### Component (B′)

Component (B′) is one or more type of glycol ether compound where a terminal hydrogen is substituted by a hydrocarbon group having 1 to 8 carbon atoms, a secondary alcoholic hydroxyl group is provided on another terminal, the repeating number of oxyalkylene units with 2 to 4 carbon atoms is a number within a range of 1 to 3, and heteroatoms other than oxygen are not included. Component (B′) is introduced into the composition as a solvent in the synthesis reaction of component (A′), and has a function of improving the handleability of the composition, or in other words, a foam stabilizer, and the compatibility with other components used in combination in the polyurethane foam formulation.

Component (B′) is preferably a monohydric organic compound having a boiling point where distillation or purification by distillation is possible, and examples of this compound include one or more types selected from glycol ethers propylene glycol monobutyl ethers, dipropylene glycol monobutyl ethers, tripropylene glycol monobutyl ethers, propylene glycol monomethyl ethers, dipropylene glycol monomethyl ethers, tripropylene glycol monomethyl ethers, propylene glycol monopropyl ethers, dipropylene glycol monopropyl ethers, tripropylene glycol monopropyl ethers, propylene glycol monoethyl ethers, dipropylene glycol monoethyl ethers, tripropylene glycol monoethyl ethers, and the like. Particularly preferred are one or more type of glycol ethers selected from dipropylene glycol monobutyl ether and tripropylene glycol monobutyl ether.

Here, the mass ratio of component (A′):component (B′) is in a range of 20:80 to 60:40.

### Component (K)

Component (K) is a potassium salt having a monovalent counter anion containing only carbon, hydrogen, and oxygen, having 1 to 8 carbon atoms, and not containing a benzene ring structure, and is a characteristic configuration of the composition of the present invention. When the above-mentioned component (A′), component (B′) and component (K) are used in combination and the amount of potassium cation (cation: K⁺) in component (K) is within a certain range, it is possible to provide specifically enhanced surfactant ability and foam retention to the present composition. Here, in order to achieve the technical effects of the present invention, the counter anion of component (K) must not be a polyvalent anion having a valence of two or more, an alkyl group having more than 9 carbon atoms, or have a benzene ring (aromatic ring) structure. When a potassium salt containing such a counter anion is used, compatibility with other components and foam-enhancing properties of the foam stabilizer may not be achieved.

Examples of such a component (K) include potassium hydrogen carbonate, potassium acetate, potassium propionate, potassium butyrate, potassium isobutyrate, potassium 2-ethylhexanoate, and the like. In addition, the counter anion particularly preferably has 1 to 4 carbon atoms. Particularly preferred examples of component (K) are potassium acetate or potassium hydrogencarbonate.

The amount of component (K) used is such that the amount of potassium cation (K⁺) in component (K) is in a range of 3 to 300 wt. ppm, more preferably in a range of 3 to 100 wt. ppm, and most preferably in the range of 3 to 50 wt. ppm, relative to the sum of component (A′) and component (B′). When the amount of component (K) is within the above range, the foam-enhancing properties of the composition and a foam stabilizer containing the composition are remarkably improved as compared with the case of using component (A′), component (B′) or a combination thereof at a specific mass ratio. On the other hand, the amount of component (K) to be used has a critical meaning, and if it is out of the above-mentioned range, the technical effects such as foam-enhancing properties may not be sufficiently achieved.

Specifically, component (K) is a soluble potassium salt, and thus has excellent compatibility with the other components, but if the amount is less than the lower limit, the amount may be too small to exhibit foam-enhancing properties, and an amount that exceeds the upper limit is disadvantageous in terms of cost effectiveness, and in addition, may precipitate in the system beyond the limit of the compatibility balance of the blending system to rather exhibit defoaming or foam-inhibiting effects.

When an alkali metal salt other than potassium salt, such as a sodium salt, is used, the salt tends to precipitate in the system because the salt has lower compatibility with other components than potassium salt, and a defoaming or foam-inhibiting effect may be exhibited.

### Technical and Industrial Significance of the Composition

Since component (K) improves the foam-enhancing property of the foam stabilizer, when the present composition is used in a urethane foam or the like, sufficient foam volume can be achieved even when a small amount is used as compared with conventionally known (AB)n type polyether-modified silicone foam stabilizers, which is advantageous from the viewpoint of cost when used as a foam stabilizer. In addition, even when the present composition is used for a foam design (formulation) in which the amount of a foaming agent or entrained gas is increased, the foam can be homogenized and stabilized as compared with a conventional foam stabilizer, and thus it is expected that the strength can be easily maintained even in a low-density and lightweight foam.

The present composition is advantageous in that effective foam-enhancing properties can be achieved simply by including a specific amount of a soluble potassium salt in the system, and as compared with a conventional technological approach where a co-surfactant or the like, that is conventional technology, is used in combination with a silicone foam stabilizer to pursue fine cell formation, prior investigation for optimizing the effect of the co-surfactant or the like on compatibility, solubility and foam-enhancing properties is not required, and industrial production and introduction are simple. Therefore, this technology is expected to meet the needs of the polyurethane foam industry that is seeking energy conservation and cost reduction for commercial activity.

In addition, the present composition improves the overall effect of the foam stabilizing performance derived from the quality of the raw materials, such as viscosity and molecular weight of component (A′) and lot variation and acid number variation of component (B′), thus comprehensively resolving quality or manufacturing issues directly related to industrial production costs of polyether-polysiloxane block copolymer compositions, as well as application issues, which have been difficult to overcome using conventional technology. Thus it is expected that (AB)n type polyether-modified silicone foams can be used as a high-performance raw material.

### Component (S)

Component (S) is one or more liquid compounds that are solvents of component (K) selected from (S1) water, (S2) monohydric saturated alcohols having 1 to 4 carbon atoms, and (S3) saturated diol compounds having 3 to 9 carbon atoms. As (S3), a saturated diol compound containing at least one secondary hydroxyl group in one molecule, having a chemical formula containing only carbon, hydrogen, and oxygen, and having 3 to 9 carbon atoms is particularly preferred from the viewpoint of compatibility with the compounding system. By using component (S), the potassium salt containing the counter anion can be uniformly and easily added to the system. Note that component (S) preferably has excellent solubility with component (K), compatibility with other components, and safety, and may be a mixture of two or more types selected from components (S1) to (S3). Furthermore, Component (S) may be removed in whole or in part from the composition by stripping or other known means after component (K) is added to the system.

(S1) is water, and is preferably water containing little impurity such as ion-exchanged water, pure water, ultrapure water, purified water, distilled water, tap water, and the like.

Specific examples of (S2) include methanol, ethanol, n-propyl alcohol, isopropyl alcohol, n-butanol, isobutyl alcohol, and the like. Methanol and ethanol are preferable from the viewpoint of the solubility of the salt, and ethanol or isopropyl alcohol are preferable from the viewpoint of safety.

Specific examples of (S3) include propylene glycol, dipropylene glycol, tripropylene glycol, 1,3-butylene glycol, 1,2-pentanediol, 1,2-hexanediol, 2-methyl-2,4-pentanediol (hexylene glycol), 2-ethyl-1,3-hexanediol, glycerin monohexyl ether, glycerin monocyclohexyl ether, and the like. From the viewpoint of solubility of the salt, propylene glycol, dipropylene glycol, 1,2-pentanediol, 1,2-hexanediol, and glycerin mono(methyl to propyl) ether are preferable. From the viewpoint of compatibility with the composition, tripropylene glycol, 1,2-pentanediol, 1,2-hexanediol, 2-methyl-2,4-pentanediol, and glycerin mono(butyl (C4) to hexyl (C6)) ether are preferable. When the composition of the present invention is mixed with a polyetherpolyol for urethane foam or the like to form a premix liquid, these preferred (S3) compounds are effective in assisting compatibility with the polyetherpolyol as component (A′) and improving storage stability. When a saturated diol compound containing two primary hydroxyl groups in one molecule, such as ethylene glycol, diethylene glycol, triethylene glycol or polyethylene glycol, is used as (S3), the saturated diol compound can be clearly dissolved in the composition of the present invention if used in a small amount, but the saturated diol compound acts as a cell opener in the process of forming a polyurethane foam because it has high polarity and is essentially inferior in compatibility with the composition of the present invention. In other words, the saturated diol compound is likely to be disadvantageous in a case where it is desired to obtain a fine cell structure or foam cell volume. However, for the purpose of balancing foam properties such as air permeability and foaming phenomenon, these (S3) components can be used in combination with the above-mentioned preferred (S3) components, or the like.

Here, when component (S) is removed in the manufacturing process of the present composition, it is particularly preferable to use one or more solvents selected from water, methanol and ethanol as component (S). On the other hand, if component (S) is not removed from the composition, it is particularly preferable to use one or more liquid compounds selected from propylene glycol, 1,2-pentanediol, and 1,2-hexanediol.

The amount of component (S) used should be in the range of 20 to 15,000 wt. ppm, relative to the sum of component (A′) and component (B′).

### Component (C)

Component (C) is a polyether compound that is compatible with component (A′), component (B′), and component (K), and is selected from the following components (C1) to (C3). By mixing and homogenizing the entire composition, the viscosity of the composition of the present invention can be adjusted without adversely affecting the function of the composition as a foam stabilizer or surfactant, thereby improving convenience in use and handling. Furthermore, component (C) can be and is preferably used in order to adjust the hydroxyl value in a polyurethane foam-forming composition containing the present composition, or in other words, in order to control crosslinking density, strength, and other various physical properties of the polyurethane foam. Note that the timing at which component (C) is added to the system can be arbitrarily selected.

(C1) Polyethermonool expressed by the following general formula (2).

### General Formula (2):

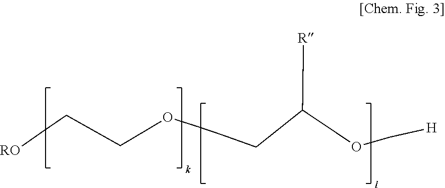 [0087] (where R represents a monovalent hydrocarbon group having 1 to 9 carbon atoms and having no aliphatic unsaturated bonds, R″ represents a methyl group or an ethyl group, k satisfies the conditions of 0≤k≤20, l satisfies the conditions of 4≤l≤50, and the amount of the oxyethylene moiety in the polyether moiety is 60 wt. % or less). A preferred example of component (C1) is polypropylene glycol n-butyl ether where k=0, R=n-C₄H₉, and R″=CH₃, which has the advantages of easy handling and inexpensive availability.

In particular, those in the range where 4≤l≤33 have excellent compatibility with the above-mentioned composition and are preferred. Furthermore, when a low VOC is desired, or the concentration of hydroxyl groups derived from (C1) is to be reduced, a range of 10≤l≤33 is preferable.

(C2) Polyetherdiol expressed by the following general formula (3).

### General Formula (3):

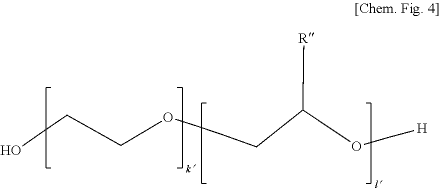 [0091] (where R″ has the same meaning as defined above, k′ satisfies the conditions 0≤k′≤10, l′ satisfies the conditions 4≤l′≤70, and the amount of oxyethylene moiety in the polyether moiety is 30 wt. % or less)

Preferred examples of component (C2) include polypropylene glycol where k′=0 and R″=CH₃, which has the advantages of easy handling and inexpensive availability. In particular, those where 4≤l′≤34 will have excellent compatibility with the above-mentioned composition and are preferred.

(C3) a polyethertriol containing 20 wt. % or less of an oxyethylene moiety and an average molecular weight in a range of 500 to 4500 and obtained by addition polymerization of an alkylene oxide having 2 to 4 carbon atoms to glycerin and/or trimethylolpropane.

Preferable specific examples of component (C3) include polyethertriols obtained by addition polymerization of propylene oxide to glycerin, and those having an average molecular weight of approximately 1500 to approximately 3500 are preferable because handling is easy and compatibility with the composition is particularly excellent.

Component (C) may be included within a range in which the amount of component (A′) is 1% by mass or more with respect to the composition.

### Antioxidants

The polyether-polysiloxane block copolymer composition of the present invention is gradually oxidized and deteriorated by oxygen in the air. In order to prevent this, phenols, hydroquinones, benzoquinones, aromatic amines, vitamins, or other antioxidants can be and are preferably added to increase oxidation stability. For example, BHT (2,6-di-t-butyl-p-cresol), vitamin E, and the like can be used as the antioxidant.

The antioxidant is preferably within a range of 1 to 1000 wt. ppm, more preferably 50 to 500 wt. ppm, per 100 parts by mass of the sum of components (A′), (B′), and optionally (C).

### Other Optional Components

The present composition is preferably used mainly as a surfactant or the like, and may contain other organic modified silicones such as polyether-modified silicones, straight silicones, organic surfactants, and the like as long as the technical features thereof are not impaired. In this case, the amount of these components is preferably in a range that does not exceed the mass of component (A′) in the entire present composition. Note that such a composition can also be suitably used as a surfactant or the like, particularly as a foam stabilizer for polyurethane foam.

A buffering agent component different from component (K) may be added to the present composition within a range that does not impair the technical effects of the present invention, depending on the production method described below. More specifically, examples of the buffering agent that can be used in the present invention include potassium salts and sodium salts other than component (K), and the buffering agent is preferably blended in the present composition in the form of a buffering agent solution in which the buffering agent is dissolved or dispersed in component (S). By using the buffering agent, in particular, an increase in the acid value of the composition due to component (B), the hydrosilylation reaction catalyst, and the like can be suppressed, and quality can be stabilized in some cases.

Examples of the potassium salt or sodium salt serving as a buffering agent include, but are not limited to, potassium carbonate, sodium carbonate, sodium hydrogen carbonate, sodium acetate, sodium propionate, sodium butyrate, sodium isobutyrate, sodium 2-ethylhexanoate, sodium benzoate, potassium benzoate, sodium lactate, potassium lactate, sodium laurate, potassium laurate, sodium oleate, potassium oleate, and the like. In addition, it is particularly preferable that the atoms constituting the chemical formula of the salt include only carbon, hydrogen, and oxygen, and that the number of carbon atoms is in a range of 1 to 4. The most preferred salt is sodium acetate.

The amount of the buffering agent and buffering agent solution used are such that the amount of buffering agent component is not more than 100 wt. ppm in terms of potassium or sodium based on the actual amount of components (B′) described below.

At least a portion of the components usable in the polyurethane foam-forming composition described below may be added beforehand as other optional components to the present composition, and mixed and homogenized, within a range that does not impair the technical effects of the present invention.

Although an organic solvent may be used in the present composition, the use and contamination of an aromatic hydrocarbon solvent such as a BTX (benzene, toluene, xylene) solvent can be avoided, including in the following production method, so it is possible to meet the current needs of the polyurethane industry which require strict VOC/emission control and prohibit the use of BTX and the like.

### Composition

The present composition contains components (A′), (B′), (K) and other optional components, and each of the components may be optionally mixed and homogenized using component (C), and the viscosity of the entire composition at 25° C. is preferably in a range of 100 to 35,000 mm²/s. It is particularly preferable to adjust the amount of component (C), component (A′), and component (B′) in the present composition to meet the proper viscosity range or according to the physical properties of the polyurethane foam required.

### Use of the Present Composition

The polyether-polysiloxane block copolymer composition of the present invention has a polyether site and a silicone site with mutually different hydrophilicity in a molecule, and therefore can be used without particular limitation in conventionally known applications of a polyether-polysiloxane block copolymer, and can be used without particular limitation in surfactants, foam stabilizers, fiber lubricity imparting agents, softening agents, surfactants, coating agents, reactive raw materials of other polymeric materials, and the like. The polyether-polysiloxane block copolymer composition of the present invention is useful as an industrial or cosmetic surfactant, where the formulation destination is paint, coating agents, construction materials, cosmetics, hydrophilicity imparting agents, surface treating agents, foaming resin compositions, and the like, and is not particularly limited. Furthermore, based on a function as a surfactant, the composition is particularly useful as a paint additive, emulsifier, solubilizer, foam stabilizer for polyurethane foam, or cosmetic raw material.

A particularly preferred application of the present composition is a surfactant, a foam stabilizer for polyurethane foam, or a premix liquid for polyurethane foam, and the use as a foam stabilizer will be described in more detail below. In the present specification, polyurethane foam may be referred to as “polyurethane foam” or just “foam”.

### Use as Foam Stabilizer

As described above, the polyether-polysiloxane block copolymer composition of the present invention has significantly improved foam-enhancing properties, is relatively easy to produce, is less susceptible to quality effects derived from raw materials, and has excellent cost-in-use characteristics, and thus is suitable for use as a surfactant for foam control or foam stabilization, especially as a foam stabilizer in the production of foaming resins, especially polyurethane foam.

In particular, when used as a foam stabilizer for polyurethane foam or as a premix solution for polyurethane foam, the present composition is not only a foam stabilizer, but also has the advantages of easy control and design of open cell ratio, excellent homogeneity and stability of the premix solution, excellent compatibility with various components in emulsion compositions for foam formation, and also has the advantages of excellent compatibility with various components and excellent foam-forming properties for microcellular applications and low repellent foam applications.

### Method for Manufacturing the Present Composition

The present composition of the present invention can be produced by a step of hydrosilylating the (a1) double-terminated alkenyl group-containing polyether and the (a2) double-terminated SiH group-containing organopolysiloxane under the presence of component (B′) to synthesize component (A′), and the step of adding component (K) before or after the hydrosilylating reaction, and may optionally further include a step selected from the steps of filtering the obtained composition, removing the solvent of component (K) and adding component (C). Each of components will be described in detail below.

### Raw Material Component (a1)

Component (a1) is a polyether containing an alkenyl group at both terminals as expressed by the following general Formula (4):

Y—O(CₓH₂ₓO)_{y}—Y [Chem. Fig. 5]
(wherein x is a number 2 to 4, y represents a number such that the molecular mass of the polyether moiety expressed by (CₓH₂ₓO)_{y} is in a range of 400 to 5000, Y represents a monovalent hydrocarbon group having 2 to 8 carbon atoms and having a reactive C═C group at a terminal, and the polyether moiety includes at least one oxypropylene group), that provides the polyether-polysiloxane block copolymer (A′) by a hydrosilation reaction with component (a2) described below.

Here, group Y can be selected from vinyl groups, allyl groups, methallyl groups, isoprenyl groups, hexenyl groups, octenyl groups and the like, but allyl groups and/or methallyl groups are particularly preferable. y is preferably a number such that the molecular weight of the polyether moiety expressed by (CₓH₂ₓO)_{y} is in a range of 1500 to 5000, and the mass ratio of oxyethylene (C₂H₄O) units in the entire polyether moiety is preferably on average within a range from 30 to 80%.

Component (a1) is generally produced by subjecting an alcoholate of a hydroxyl-terminated polyether and a strong alkali to a nucleophilic displacement reaction with an alkenyl halide, and then removing low-boiling substances, by-product salts, and the like. In this reaction, the blocking ratio of the hydroxyl group is not complete in many cases, and a slight amount of hydroxyl group is usually contained as an impurity in group Y. The blocking rate is preferably 90 mol % or higher, more preferably 95 mol % or higher, and particularly preferably 98 mol % or higher.

The amount of water included in component (a1) is preferably 0.5 wt. % or less, more preferably 0.2 wt. % or less, particularly preferably 0.1 wt. % or less. Component (a1) easily absorbs moisture, so a dehydration process may be performed in the reactor vessel before starting the hydrosilylation reaction, depending on the situation.

In addition, component (a1) is susceptible to oxidative degradation, so an oxidation inhibitor may be added and dissolved in the raw materials in an amount of approximately 100 to 1000 ppm after completion of the synthesis of component (a1). One example of a suitable antioxidant is vitamin E.

### Raw Material Component (a2)

Component (a2) is an organopolysiloxane containing a SiH group on both terminals, expressed by General Formula (5)

### General Formula (5)

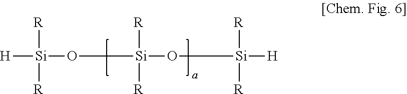 [0118] (where each R independently represents a monovalent hydrocarbon group having 1 to 9 carbon atoms and having no aliphatic unsaturated bonds, and a represents a number of 1 to 200), and provides the polyether-polysiloxane block copolymers (A′) which are obtained by a hydrosilation reaction with the aforementioned component (a1).

Here, a particularly preferred R is a methyl group. In addition, from the viewpoint of usefulness and handleability of the produced foam stabilizer, a in the general formula (5) is preferably a number in a range of 10 to 45.

Component (a2) is usually produced by charging an organodisiloxane containing SiH groups at both ends and a low molecular weight cyclic diorganosiloxane in a desired molar ratio, polymerizing the mixture in the presence of an acidic catalyst, neutralizing the catalyst after reaching an equilibrated state, and removing neutral salts and the like. Due to the nature of the equilibration reaction, a low molecular weight cyclic diorganosiloxane corresponding to 10 to 15 wt. % generally remains in the product system, in addition to the target organopolysiloxane having SiH groups at both terminals.

When the polyether polysiloxane block copolymer composition according to the present invention is used as an aromatic hydrocarbon-based solvent-free and low VOC/emission foam stabilizer for polyurethane foam, the composition preferably contains substantially no low molecular weight siloxanes with 20 or fewer silicon atoms.

On the other hand, in the method for manufacturing the present composition, it is preferable not to have a stripping step after the synthesis of the copolymer (in other words, after the hydrosilylation reaction), and there is an advantage that a foaming phenomenon or the like hardly occurs during the process and production efficiency is excellent. Therefore, low molecular weight siloxanes, particularly low molecular weight cyclic siloxanes, are preferably removed from component (a2) in advance. There are many methods for removing the low molecular weight siloxanes from Component (a2). Examples include: a method of treating under high temperature and high vacuum while an inert gas such as argon gas, nitrogen gas, or the like is blown in small amounts into an equilibrium mixture of organopolysiloxane containing an SiH group; a method of thinning the equilibrium mixture of organopolysiloxane containing an SiH group and then stripping under heating conditions of 50 to 130° C. under a reduced pressure of 0.5 mm or less, for example; and a method of dissolving the low molecular weight siloxane in the equilibrium mixture of the organopolysiloxane containing an SiH group, adding an organic solvent that does not dissolve the high molecular weight siloxane, such as an organic solvent like methanol, ethanol, or acetone, and then extracting and removing the low molecular siloxanes.

Specifically, component (a2) preferably has a total content of 3000 ppm (by weight) or less of low molecular weight cyclic siloxane containing 6 or fewer silicon atoms, and 300 ppm (by weight) or less is particularly preferred. These low molecular weight cyclic siloxanes are typically cyclic dimethyl siloxane expressed by the formula, [(CH₃)₂SiO]ₙ (where n is an integer from 3 to 10).

### Raw Material Component (K) and Solvent Component (S)

Component (K) and component (S) are, as already explained, potassium salt and a solvent thereof, and their use is as described above.

Component (K) may be added alone to the system, but is preferably added in the form of a solution in which component (K) is dissolved in component (S) beforehand. By making a solution of component (K), component (K) can be dispersed in the system much more uniformly and finely as compared with the case where component (K) alone (solid particles) is directly mixed as is with the raw material system. In addition, adding component (K) in the form of a solution with component (S) is also advantageous in terms of the appearance (transparency) of the composition (product), and in the case where a filtration purification step is performed also has an advantage in that the burden thereof is reduced.

The concentration of component (K) in component (S) may be designed according to the type of component (K) and the solubility in component (S) that is selected, and is practically in a range of 0.5 to 20 wt. %, preferably 1 to 10 wt. %. Note that if component (S) is (S1) water, it will likely be a good solvent for component (K), which is a potassium salt, and depending on the type of the salt, the salt may be dissolved at a concentration of 50 wt. % or more. Such a high-concentration solution may be used as is, but it should be noted that the number of parts added as a solution becomes smaller, and thus the impact of a measurement error becomes larger. In addition, it is necessary to pay attention and take measures to ensure that the raw materials can be fed quantitatively without loss and that the raw material does not stagnate in the feed line. The mixture of components (S) and (K) may be prepared by a method in which a highly concentrated aqueous solution is first prepared with water (S1) and then diluted with an appropriate amount of (S2) and/or (S3).

As described for component (S), in the production method of the present invention, when component (S) is removed, one or more solvent selected from water, methanol, and ethanol is particularly preferably used. On the other hand, if component (S) is not removed, it is particularly preferable to use one or more solvents selected from propylene glycol, 1,2-pentanediol and 1,2-hexanediol.

Component (K), preferably in the form of a mixed solution containing component (S), can be mixed with the above-mentioned component (a1), or with the composition after the hydrosilylation reaction. Herein, the difference in timing of adding component (K), preferably the mixed solution in which component (K) is dissolved in component (S) is closely related to the first production method and the second production method according to the present invention.

In the first production method, component (K), preferably a mixed solution of component (K) dissolved in component (S), is added to the component (a1) before the hydrosilylation reaction, whereby uniform and fine dispersion of component (K) in the system is achieved. Furthermore, pre-dispersing component (K) in component (a1) has an advantage of effectively neutralizing acid impurities in the raw material (especially those due to the quality of component (B′), and the like). Note that component (S) may optionally be removed from the raw material system before the start of the hydrosilylation reaction in order to inhibit side reactions, and the like.

On the other hand, with the second production method, a mixed solution of component (K), preferably component (K) dissolved in component (S), is added to the composition after the hydrosilylation reaction of component (a1) and component (a2). On the other hand, it is optional to add component (K) during the hydrosilylation reaction.

### Raw Material Component (B′)

Component (B′) is the glycol ether compound described above, and the amount used is as described above. In the production method of the present invention, component (B′) functions as a solvent for component (A′) and the raw material components thereof in the hydrosilylation reaction, and becomes component (B′) in the composition of the present invention as a result of being used as a solvent in the synthesis reaction.

When a single glycol ether is used in the manufacturing method of the present invention, the purity is preferably at least 90 wt. % or higher. Preferably, the purity is 95 wt. % or higher, particularly preferably 98.5 wt. % or higher. When a plurality of types of glycol ethers are used in combination as raw material iv), the purity of each glycol ether is preferably high as described above.

In addition, as described above, component (B′) may contain a trace amount of an acidic substance depending on the manufacturer and the storage conditions, or the like. The amount of acidic substance in component (B′) is preferably 0.02 wt. % or less, more preferably 0.01 wt. % or less, and especially preferably 0.001 wt. % or less.

The amount of water included in component (B′) is preferably 0.5 wt. % or less, more preferably 0.2 wt. % or less, particularly preferably 0.1 wt. % or less. Component (B′) easily absorbs moisture, so a dehydration process may be performed in the reactor vessel before starting the hydrosilylation reaction, depending on the situation.

Note that in the present invention, when a certain amount of component (K) is used and the amount of component (A′) and component (B′) to be used after synthesis satisfies the above ranges, there is an advantage that the effects due to the quality of component (B′), which is an acidic substance, can be reduced.

### Raw Material Component: Hydrosilylation Reaction Catalyst

In the manufacturing method of the present invention, the aforementioned component (a1) and component (a2) are hydrosilylated in the presence of an effective amount of hydrosilylation reaction catalyst to form component (A′). Here, the hydrosilylation reaction catalyst is not limited to a specific catalyst so long as it can promote the hydrosilylation reaction, and the catalyst can be appropriately selected from known hydrosilylation reaction catalysts and used in the present invention. Specific examples of the hydrosilylation reaction catalyst can include fine particulate platinum adsorbed on silica fine powder or a carbon powder carrier, chloroplatinic acids, alcohol-modified chloroplatinic acids, olefin complexes of chloroplatinic acid, coordinate compounds of chloroplatinic acid and vinyl siloxane, platinum such as platinum black, and the like.

In the manufacturing method of the present invention, a particularly preferable hydrosilylation reaction catalyst is a neutral platinum complex catalyst, and 1,3-divinyl-1,1,3,3-tetramethyldisiloxane platinum complex is particularly preferable. On the other hand, when an acidic hydrosilylation reaction catalyst such as chloroplatinic acid or alcohol-modified chloroplatinic acid is used, it may be necessary to use or increase the amount of the buffering agent component described below.

However, if the total mass of components (a1) and (a2) is taken as 100% by mass, the amount of metallic atoms (in particular, platinum group metallic atoms) in the hydrosilation catalysts is within a range of 0.1 to 200 ppm by mass, preferably 1 to 50 ppm by mass. This is because when the amount of hydrosilylation reaction catalyst is less than the lower limit, the copolymerization reaction may be insufficient, and if the amount exceeds the upper limit, coloring and transparency of the obtained composition may be adversely affected in addition to being uneconomical.

### Raw Material Components: Buffering Agent and Buffering Agent Solution

In the production method according to the present invention, the above-mentioned buffering agent or a buffering agent solution in which the buffering agent is dissolved or dispersed in the above-mentioned component (S) can be used. In particular, potassium salts and sodium salts as buffering agents are added in the form of a buffering agent solution using component (S) to the starting material system containing component (a1), and similar to component (K), a much more uniform fine dispersion is achieved as compared with the case where an alkali salt as a buffering agent is directly mixed in the starting material system in the form of solid particles. Note that the solvent as component (S) can be optionally removed from the raw material system before the start of the hydrosilylation reaction for the purpose of suppressing side reactions, but there is an advantage that acid impurities (particularly those derived from component (B′) and the hydrosilylation reaction catalyst described later) in the raw material system can be effectively neutralized with the minimum required amount by finely dispersing the salt component in advance. Note that there is an advantage in that side reactions during the hydrosilylation reaction can be reduced by removing component (S) after finely dispersing the buffering agent and the like in the raw material system. Note that if component (S) is not removed, a buffering agent or a buffering agent solution using component (S) may be added to the composition after the hydrosilylation reaction.

When a buffering agent solution is prepared using component (S), the concentration of alkali metal salt as a buffering agent can be designed based on the solubility in the component (S) to be used, but for practical use, the concentration is in a range of 0.5 to 20 wt. %, preferably 1 to 10 wt. %. Note that (S1) water is often a good solvent for buffering agents, and depending on the type of salt that is the buffering agent, it may be possible to dissolve at a concentration of 30 wt. % or higher. Such a high-concentration solution may be used as is, but it should be noted that the number of parts added as a solution becomes smaller, and thus the impact of a measurement error becomes larger. In addition, it is necessary to pay attention and take measures to ensure that the raw materials can be fed quantitatively without loss and that the raw material does not stagnate in the feed line. Note that when preparing the buffering agent solution, a method may be used in which a high-concentration aqueous solution is first prepared, and then an appropriate amount of component (S2) and/or component (S3) is added to dilute.

Hereinafter, the method of producing the present composition using the above-mentioned raw materials will be described more specifically. As described above, the production method of the present invention can be the first production method or second production method, depending on the timing at which component (K), particularly preferably a mixed solution obtained by dissolving component (K) in component (S) (hereinafter sometimes referred to as “component (K) and the like”) is added to the production system. Note that a combination of these two manufacturing methods, where component (K), preferably a mixed solution of component (K) dissolved in component (S), is added to the manufacturing system in a plurality of steps, is also included in the embodiment of the manufacturing method of the present invention.

### First Method of Manufacturing

The first production method requires a step of pre-mixing component (K) and the like with component (a1) prior to the hydrosilylation reaction. Note that the first production method may optionally include a step of removing the solvent used during addition, after the step of mixing component (K) and the like.

More specifically, the first method for producing a composition containing a polyether-polysiloxane block copolymer (A′) according to the present invention includes as required steps:
Step (I):
a step of mixing component (a1) and component (K), and
Step (II):
a step of performing a hydrosilylation reaction between the mixture obtained in step (I) and component (a2) in the presence of component (B′) and an effective amount of a hydrosilylation reaction catalyst (however, the amount of potassium cation (K⁺) in component (K) relative to the sum of component (a1), component (a2), and component (B′) is in a range of 3 to 300 wt. ppm, and the mass ratio of the sum of component (a1) and component (a2):component (B′) is within a range of 20:80 to 60:40)
and optionally including, after step (I),
a step of removing component (S) which is the solvent used when adding component (K) outside of the system by heating and/or pressure reduction.

### Second Method of Manufacturing

The second production method essentially includes a step of post-mixing component (K) and the like with the reaction product after the hydrosilylation reaction. Note that the second production method may optionally include a step of pre-mixing the buffering agent or buffering agent solution with component (a1), and a step of removing the solvent used when adding the buffering agent after the mixing step.

More specifically, the second method for producing a composition containing a polyether-polysiloxane block copolymer (A′) according to the present invention includes as required steps:
Step (I′):
a step of performing a hydrosilylation reaction between component (a1) and component (a2) in the presence of component (B′) and an effective amount of a hydrosilylation reaction catalyst (however, the mass ratio of the sum of component (a1) and component (a2):component (B′) is in a range of 20:80 to 60:40), and
Step (II′)
a step of adding component (K) to the composition after the hydrosilylation reaction of Step (I′) and mixing both components (however, the amount of potassium cation (K⁺) in component (K) relative to the sum of component (a1), component (a2), and component (B′) is in a range of 3 to 300 wt. ppm)
and optionally including, before step (I′),
a step of adding the buffering agent or buffering agent solution to the raw material system including at least component (a1), mixing, and then removing component (S) which is the solvent used when adding the buffering agent outside of the system by heating and/or pressure reduction.

### Filtration Step

The method for manufacturing the present composition preferably further includes a step of optionally filtering the obtained composition after step (II) or before or after step (II′). Herein, means such as a filter and a filter medium used for filtration can be appropriately selected depending on the production scale and the kind or degree of foreign matter, but from the viewpoint of reducing waste, ensuring the safety of workers, working efficiency, and ensuring the quality and performance of the present composition in use as a foam stabilizer, it is preferable to use a zeta potential adsorption filter, a bag filter, a cartridge filter, or the like.

The filtration step is not particularly limited, but the composition after the hydrosilylation reaction can be filtered so that the light transmittance (at 580 nm) is 90% or more, more preferably 95% or more.

### Other Reaction Conditions

In the hydrosilation process of the present invention, the amount of terminal alkenyl groups (R-Vi) in component (a1) is preferably equal to or slightly in excess of the amount of silicon-bonded hydrogen atoms (Si—H) in component (a2), and more specifically, the amount ratio (molar ratio) represented by [R-Vi]/[Si—H] is preferably 1.0 to 1.5, particularly preferably 1.1 to 1.3.

The polyether-polysiloxane block copolymer composition of the present invention is as described above, but in general, there is a correlation in compatibility between the type of foam resin and silicones containing a polyether portion, which is a foam stabilizer, and when arranging from foam suitable for low molecular weight bodies to foam suitable for high molecular weight bodies, the order is high resilience foam<hard foam<soft foam<microcellular foam.

Furthermore, the structure of the polyether portion also greatly affects the size of the foam and the like, and therefore, techniques exist for increasing the molecular weight distribution of a polyether portion and the like, such as selecting a polyether structure with a high amount of EO if reduced cell size and air permeability are desired, selecting a polyether with a high molecular weight if foam stabilization and retention are desired, widening the processing range, using a plurality of polyethers with different molecular weights or structures in raw material in order to have compatibility with a wide range of applications and formulations, and the like, which can also be applied to the polyether-polysiloxane block copolymer composition of the present invention and to the manufacturing method thereof. Furthermore, a polyol which is one primary raw material of polyurethane has a PPG structure portion, and therefore, a PO (propyleneoxy) chain is often preferably also included in the polyether portion in the polyether-modified silicone from the perspective of compatibility in a foam formulation.

The requirements of the foam stabilizer will be different based on the type of polyurethane foam containing the “aromatic hydrocarbon solvent free (AB)n type polyether-modified silicone foam stabilizer”, but for example, the surface activating performance, affinity to the urethane foam system, or the like can be controlled based on appropriately adjusting the chain length of the organopolysiloxane having a SiH group on both terminals as expressed by General Formula (5), the type of polyether having an alkenyl group on both terminals as expressed by General Formula (4), the reaction ratio between both components, and the EO/PO % or molecular weight of the polyether moiety, and therefore, a suitable foam stabilizer can be freely designed as desired.

The hydrosilylation reaction conditions of the present invention can be arbitrarily selected, but the composition can be obtained by adding a small amount of an antioxidant such as tocopherol (vitamin E), or the like, and then heating and stirring at a temperature of room temperature to 200° C., and preferably 50 to 100° C., under an inert gas atmosphere such as nitrogen or the like. Note that the antioxidant may be added after the hydrosilylation reaction is completed. The reaction time can be selected based on the reaction scale, amount of catalyst used, and reaction temperature, and is generally within a range of several minutes to several hours. Furthermore, the reaction may be performed under reduced pressure in order to improve quality or the like, and for example, the reaction conditions proposed in Patent Document 4 (Japanese Unexamined Patent Application Publication H11-116670) can be applied without particular limitation.

The end point of the hydrosilylation reaction can be confirmed by the disappearance of Si—H bond absorption by infrared spectroscopy (IR), or the absence of hydrogen gas generation by the following alkali decomposition gas generating method. Note that the silicon-bonded hydrogen atoms (Si—H) in the organopolysiloxane containing a SiH group on both terminals which is a reaction raw material can be analyzed by the same method, and therefore, the amount of hydrogen gas generation can be specified. The following is a summary thereof.
<Alkali decomposition gas generating method: Method of reacting at room temperature a 28.5 mass % caustic potash ethanol/water mixed solution with a solution where a sample is dissolved in toluene or IPA, collecting the generated hydrogen gas in a collection tube, and then measuring the volume thereof>

The method for manufacturing the present composition preferably does not include a stripping step after the step of synthesizing the polyether-polysiloxane block copolymer (A′) by a hydrosilylation reaction. This is to avoid a foaming phenomenon during the process in the manufacturing step after the synthesis of component (A′). Note that the composition containing the aforementioned component (A′) and component (B′) as main components preferably has a viscosity at 25° C. that is within a range of 100 to 60,000 mm²/s, from the perspective of convenience during use, handling, and the like.

### Addition of Component (C)

In the method for manufacturing the present composition, the aforementioned component (C) may be added to the composition containing the component (A′) and the component (B′) as main components so that the amount of the component (A′) is 1% by mass or more, followed by mixing and homogenizing. At this time, the timing of adding Component (C) is preferably after the aforementioned step (II) or before and after step (II′), and at this time, the viscosity at 25° C. of the entire composition is preferably within a range of 100 to 35,000 mm²/s, and the amounts of component (C), component (A′), and component (B′) can be adjusted in order to satisfy the aforementioned viscosity range, or based on the physical properties of the required polyurethane foam. Note that as described above, the technical intention of adding component (C) is not limited to adjusting the viscosity and the like.

### Other Optional Components

In the method for manufacturing the present composition, the other optional components described above, Component (B′) and Component (C) may be added, mixed, and homogenized. Furthermore, in the method of manufacturing the present composition, at least a portion of the components usable in the polyurethane foam-forming composition described below may be added as other optional components to the present composition, and mixed and homogenized, within a range that does not impair the technical effects of the present invention. This is advantageous in that a homogeneous premix liquid for polyurethane foam containing a foam stabilizer component and other desired components can be prepared.

### Advantages Provided by the Production Method

The method for manufacturing the present composition is an efficient production process capable of utilizing inexpensive raw materials having varying qualities, and even if a copolymer having a desired high molecular weight or strong foam stability is designed, the problem of foam control occurring in the production process will not occur, or can be easily solved, and thus the method has excellent productivity and can comprehensively solve the problems of manufacturing directly linked to the industrial production cost and problems with quality. Therefore, by using the polyether-polysiloxane block copolymer composition obtained by the present manufacturing method, it is expected that a foam stabilizer containing the composition can be sufficiently and stably promoted in the market and can be utilized as a high-performance raw material.

As described above, the polyether-polysiloxane block copolymer composition of the present invention (including the composition obtained by the above-described manufacturing method) is particularly useful as a foam stabilizer for use in the production of polyurethane foam, and can be directly used as a surfactant or a foam stabilizer for polyurethane foam. Alternatively, the composition may be blended in a premix liquid for urethane foam and used as a system.

### Polyurethane Foam Forming Composition and Polyurethane Foam Containing This Composition

If the polyurethane foam-forming composition and polyurethane foam of the present invention include or use the polyether-polysiloxane block copolymer composition of the present invention (including those obtained by the production method described above) as at least a portion of the raw materials, there are no limitations in the type of foam, properties thereof, or the type of formulation used.

In general, polyurethane foam includes hard polyurethane foam and soft polyurethane foam, which are specifically classified into soft urethane foam, high resilience urethane foam, hard urethane foam, and special foam. For the details thereof, for example, refer to Patent Document 6 (WO 2016/166979). The composition and foam stabilizer of the present invention are versatile and when formulated into these various polyurethane foam formulations, provide benefits when incorporated into these various polyurethane foam formulations.

In addition, as described above, the composition and the foam stabilizer of the present invention can be easily made to be free of a BTX solvent and can be produced inexpensively and in large quantities, and thus are suitable for obtaining a low VOC/emission type polyurethane foam. Furthermore, the foam stabilizer facilitates manufacture of BTX-free foams, premix systems, and the like by foam manufacturers and foam formulation (system) designers. Note that in order to manufacture a polyurethane foam having less VOC/emission and less odor, it is preferable to add a non-volatile antioxidant to the polyol described below.

The polyether-polysiloxane block copolymer composition of the present invention (including those obtained by the aforementioned manufacturing method) suitably uses as one raw material: (d) a foam stabilizer in a polyurethane foam-forming composition containing the following components:
(a) a polyol;
(b) a polyisocyanate;
(c) a catalyst;
(d) the foam stabilizer according to the present invention; and
(e) optionally, at least one added component selected from a group consisting of foam stabilizers other than component (d), foaming agents, diluents, chain extenders, crosslinking agents, water, non-aqueous foaming agents, fillers, reinforcing agents, pigments, dyes, coloring agents, flame retardants, antioxidants, anti-ozone agents, UV stabilizers, anti-static agents, disinfectants, and antibacterial agents.

With respect to the raw material components of the polyurethane foam-forming composition other than the foam stabilizer (d) and the amounts used, raw materials known in the art can be selected and used, and for example, the components described in Patent Document 6 (International Patent Application Publication 2016/166979) can be considered.

Note that the foam stabilizer of the present invention can be used as a foam stabilizer suitable for most polyurethane foams. The added amount thereof is within a range where the polyether-polysiloxane block copolymer (A′) in the composition is 0.1 to 10 parts by mass, preferably within a range of 0.5 to 5 parts by mass, and more preferably 1.0 to 3.0 parts by mass, with regard to (a) 100 parts by mass of polyol.

The polyurethane foam obtained by using the “composition of the polyether-polysiloxane block copolymer (A′)” according to the present invention may be a rigid foam, a semi-rigid foam, a flexible foam, a low-resilience foam, an HR foam or a microcellular foam. Reference can be made to, for example, Patent Document 6 (International Patent Application Publication 2016/166979) for the details and the production process thereof, and these polyurethane foams can be obtained by replacing at least a portion or all of the foam stabilizers described in Patent Document 6 with the foam stabilizer of the composition according to the present invention. It is also possible to add the technique obtained in the present invention [for example, adding an appropriate amount of the component (K) of the present invention before reaction and then reacting] to the foam stabilizer or polyether-polysiloxane block copolymer composition production method described in Patent Document 3 (Japanese Unexamined Patent Application H08-156143) and the Examples and Comparative Examples of International Patent Application Publication 2021/131378 in order to enhance the foam performance and adjust the cell size in various polyurethane foams.

Furthermore, a method of manufacturing an individual polyurethane foam can be appropriately selected, but in particular, the (AB)n type polyether-modified silicone composition of the present invention can be suitably used in place of all or a portion of the silicone-based foam stabilizer, silicone surfactant, or silicone copolymer surfactant in the manufacturing method of a polyurethane foam described in the following patent publications or detailed description of the patent publications, and particularly the examples and the like. Note that the disclosure of the detailed descriptions thereof or examples include disclosures related to a manufacturing device, and a portion of components may be further substituted and manufacturing conditions thereof may be appropriately modified based on changing viscosity or the like, by normal design modifications of a person with ordinary skill in the art.
U.S. Pat. No. 7,825,205 (Japanese Patent No. 5422115)
Japanese Unexamined Patent Application Publication 2014-210832
Japanese Unexamined Patent Application Publication H07-090102
Patent Document 3 (Japanese Unexamined Patent Application H08-156143), Japanese Examined Patent Application Publication S57-014797)
Patent Document 6 (International Patent Application Publication 2016/166979)
Manufacturing methods of polyurethane foam described in Japanese PCT Patent Application 2005-534770, Japanese PCT Patent Application 2005-534770, and Japanese PCT Patent Application 2010-535931;
Manufacturing process of open cell polyurethane described in Japanese PCT Patent Application 2010-539280;
Sealing material containing urethane foam described in JP 2012-246397A, JP 2009-265425A, and the like;
Manufacturing of urethane foam described in JP 2012-082273A, JP2010-247532A, JP2010-195870A, JP2002-137234A, and the like
Manufacturing of polyurethane foam described in Japanese PCT application 2010-500447, Japanese PCT application 2010-504391, Japanese PCT application 2010-538126, Japanese PCT application 2011-528726, and Japanese PCT application 2013-529702

Furthermore, the (AB)n type polyether-modified silicone composition according to the present invention has a function as a surfactant, and therefore can also be used in known industrial applications for (AB)n type polyether-modified silicones other than polyurethane foams, for example, in fiber treatment agents, fabric softeners, paint additives, and the like.

### EXAMPLES

Hereinafter, the present invention will be further described in detail based on Examples and Comparative Examples, but the present invention is not limited thereto. Note that in the following composition formulas, a Me₃SiO group (or Me₃Si group) is expressed as “M”, a Me₂SiO group is expressed as “D”, a MeHSiO group is expressed as “M^{H}”, and units where a methyl group in M and D is modified by any substitution group is expressed as M^{R} and D^{R}. IPA represents isopropanol, MeOH represents methanol, BDPG represents dipropylene glycol monobutyl ether, PG represents propylene glycol, EO represents ethylene oxide or an oxyethylene group, and PO represents propylene oxide or an oxypropylene group. In addition, “%” in the test examples refers to weight (wt)% unless otherwise specified.

### Reference Data 1

One of the features of the composition and the production method of the present invention is that the influence of the quality of the raw materials used is alleviated and practically sufficient performance is achieved. The difference in quality depending on the supplier of BDPG is as shown in Table 1, and the BDPG of Company H and Company L are different in purity, water content, acid value and the like.

TABLE 1
Difference in quality according to supplier of BDPG

| | Company H | Company L |
|---|---|---|
| Inspection Item | (high price) | (low price) |
| Purity [wt. %] | 99.8 | 99.1 |
| Moisture [wt. %] | 0.02 | 0.01 |
| Hue (APHA) | 10 | 3 |
| Acid value [wt. %] | 0.0010 | <0.01 |
| Specific gravity (25/25° C.) | 0.914 | 0.90-0.92 |
| Distillation range (760 mmHg) | 231 | 222-232 |
| or boiling point [° C.] | | |

In the aforementioned tests, the raw material straight chain organopolysiloxane-polyether block copolymers were:
(a1-1) bismethallylpolyether expressed by the average compositional formula CH₂═C(CH₃)CH₂—O(C₂H₄O)₃₅(C₃H₆O)₂₇—CH₂—C(CH₃)═CH₂ (degree of unsaturation 0.67 meq/g, hydroxyl value 0.8 mg—KOH/g)
(a1-2) bismethallylpolyether represented by the average compositional formula CH₂═C(CH₃)CH₂—O(C₂H₄O)₃₅(C₃H₆O)₂₇—CH₂—C(CH₃)═CH₂ (degree of unsaturation 0.64 meq/g, hydroxyl value 2.1 mg—KOH/g)
(a1-3) bismethallylpolyether expressed by the average compositional formula CH₂═C(CH₃)CH₂—O(C₂H₄O)₃₅(C₃H₆O)₂₇—CH₂—C(CH₃)═CH₂ (degree of unsaturation 0.60 meq/g, hydroxyl value 3.8 mg—KOH/g).
(a1-4) bismethallylpolyether expressed by the average compositional formula CH₂═C(CH₃)CH₂—O(C₂H₄O)₃₅(C₃H₆O)₂₇—CH₂—C(CH₃)═CH₂ (degree of unsaturation 0.63 meq/g, hydroxyl value 0.7 mg—KOH/g)
* Remarks: (a2-1) to (a2-3) correspond to raw materials of bismethallyl polyethers of different lots.
(a2-1) a methylhydrogenpolysiloxane represented by the average compositional formula M^{H}D₂₀M^{H}
Pt catalyst (hydrosilylation reaction catalyst): 1,3-divinyl-1,1,3,3-tetramethyldisiloxane platinum complex

When the above-mentioned BDPG manufactured by Company H or Company L was used as component (B′), the BDPG is referred to as “(B′) BDPG (Company H)” or “(B′) BDPG (Company L)”.

### Initial Evaluation of Foaming (Foam Enhancing Effect) in the Test Examples

In the following test examples, the surfactant ability (foam enhancing effect) of each composition obtained was evaluated by the following methods. In other words, even after completion of the reaction, a very small amount of nitrogen gas was bubbled into the solution to replace the inside of the system in the same manner as during the reaction, and the flask was allowed to stand overnight in this state, and the composition in the flask was observed on the next day and after one week, and evaluated according to the following criteria. The results obtained by the test examples are shown in Tables 2 to 4 below.
“Excellent”: A large amount of foam is present in the entire liquid surface at the time of observation on the next day, and this state is maintained even after one week.
“Good”: A large amount of foam is present in the entire liquid surface at the time of observation on the next day, and about one third of the foam is maintained even after one week.
“Little”: Foam on the liquid surface is minimal at the time of observation on the next day.

### Light Transmittance (T %) in Each Test Example

In the following test examples, the clarity (T %) of each composition obtained was determined by measuring the light transmittance at a wavelength of 580 nm using a spectrophotometer. The results are shown in the table as T %.

### Example 1-1

46.58 g of (a2-1) methylhydrogenpolysiloxane, 103.43 g of (a1-1) bismethallylpolyether (containing 500 ppm of natural vitamin E), 150 g of (B′) BDPG (Company L), and 0.30 g of (K+S) 3% solution of potassium acetate in PG (60 wt. ppm as potassium acetate with regard to BDPG) were placed in a 500 mL reaction vessel, and then heated to 50° C. while stirring under a nitrogen gas flow. 0.07 mL of the hydrosilylation catalyst was added and aging was performed at 50 to 80° C. for 3 hours, whereupon the reaction was substantially complete.

Thereby, a light brown clear liquid polyether-polysiloxane block copolymer composition “1505 mm²/s, (25° C.)” containing the (A′) straight chain organopolysiloxane-polyether block copolymer at least containing a structural unit expressed by:

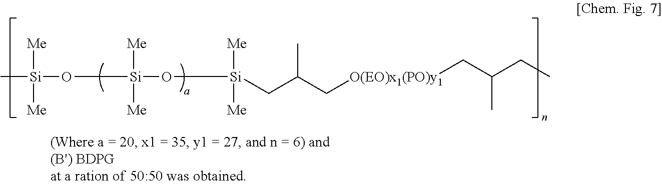

The molar ratio of C═C groups and Si—H groups in the raw materials C═C/SiH was approximately 1.20, and therefore, both terminals of the copolymer have a form blocked by a polyether (=terminal functional group is a methallyl group or hydroxyl group bonded to a polyether). Furthermore, a portion of the Si—H groups in the reaction can cause a dehydrogenative condensation reaction with a hydroxyl group of the BDPG, and therefore, a portion of the copolymer terminal is considered to include a structure of SiO-iPr or SiO-R¹ (R¹ represents a BDPG residual group). Note that herein, a polyether portion is a random adduct of ethylene oxide and propylene oxide.

### Example 1-2

A test was performed in the same manner as in Example 1-1 except that 0.02 g of a 50 wt. % solution of potassium acetate (60 wt. ppm as potassium acetate relative to BDPG) was used in place of the (K+S) 0.30 g of a 3 wt. % PG solution of potassium acetate to obtain a light yellowish brown clear liquid composition of polyether-polysiloxane block copolymer “1370 mm²/s, (25° C.)”.

### Example 1-3

A test was performed in the same manner as in Example 1-1 except that 0.60 g of a 3 wt. % PG solution of potassium acetate (120 wt. ppm as potassium acetate relative to BDPG) was used in place of the (K+S) 0.30 g of a 3 wt. % PG solution of potassium acetate to obtain a light yellowish brown clear liquid composition of polyether-polysiloxane block copolymer “1529 mm²/s, (25° C.)”.

### Example 1-4

A test was performed in the same manner as in Example 1-1 except that 0.03 g of a 30 wt. % PG solution of potassium acetate (60 wt. ppm as potassium acetate relative to BDPG) was used in place of the (K+S) 0.30 g of a 3 wt. % PG solution of potassium acetate to obtain a light yellowish brown clear liquid composition of polyether-polysiloxane block copolymer “1450 mm²/s, (25° C.)”.

### Comparative Example 1

75.25 g of (a2-1) Methylhydrogenpolysiloxane, 174.75 g of (a1-2) bismethallylpolyether, 250 g of (B′) BDPG (Company H), and 0.25 g of natural Vitamin E were introduced in a 1 L reaction vessel, and heated to 80 to 90° C. with stirring under a stream of nitrogen gas. 0.56 g of an IPA solution of a platinum 1,3-divinyl-1,1,3,3-tetramethyldisiloxane complex (Pt concentration: 0.41 wt. %) was added thereto, and the mixture was reacted for 2.5 hours. Next, a small amount of reaction liquid was collected, and when confirmed by an alkali decomposition gas generation method (the remaining Si—H groups are decomposed using a KOH ethanol/water solution, and the reaction rate is calculated from the volume of the produced hydrogen gas), the reaction was found to be completed. Thereby, an essentially clear liquid polyether-polysiloxane block copolymer composition “1680 mm²/s, (25° C.)” including the straight chain organopolysiloxane-polyether block copolymer at least containing a structural unit expressed by the average composition formula:

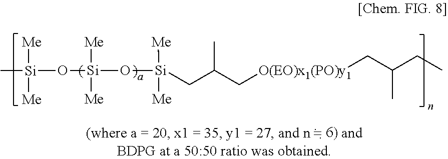

Note that the average composition formula is simply expressed, but the molar ratio of C═C groups and Si—H groups of raw materials C═C/SiH=1.18, and therefore both terminals of the copolymer have a form blocked by a polyether (=terminal functional group is a methallyl group or a hydroxyl group bonded to a polyether). Furthermore, a portion of the Si—H groups in the reaction can cause a dehydrogenative condensation reaction with a hydroxyl group of the BDPG, IPA, and the like, and therefore, a portion of the copolymer terminal is considered to include a structure of SiO-iPr or SiO-R¹ (R¹ represents a BDPG residual group). Note that herein, a polyether portion is a random adduct of ethylene oxide and propylene oxide.

### Comparative Example 2-1

45.81 g of (a2-1) Methylhydrogenpolysiloxane, 104.19 g of (a1-3) bismethallylpolyether (containing 500 ppm of natural vitamin E), and 150 g of (B′) BDPG (Company L) were placed in a 500 mL reaction vessel, and heated to 60° C. with stirring under a stream of nitrogen. 0.04 mL of hydrosilation catalyst was added, and the reaction was carried out at 60 to 80° C. for 3 hours. A small amount of the reaction liquid was collected, and the reaction was confirmed to be almost completed using an alkali decomposition gas generation method. Thereby, an opaque liquid polyether-polysiloxane block copolymer composition “931 mm²/s, (25° C.)” including the straight chain organopolysiloxane-polyether block copolymer at least containing a structural unit expressed by the average composition formula:

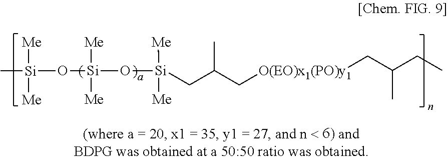

Since the molar ratio of the C═C group to the Si—H group in the starting material was C═C/SiH=1.10, it is considered that both terminals of the copolymer were mainly blocked with polyether (=the terminal functional group is a methallyl group or a hydroxyl group bonded to polyether). Note that herein, a polyether portion is a random adduct of ethylene oxide and propylene oxide.

### Comparative Example 2-2

45.81 g of (a2-1) methylhydrogenpolysiloxane, 104.19 g of (a1-3) bismethallylpolyether (containing 500 ppm of natural vitamin E), 150 g of (B′) BDPG (Company L), and 0.009 g of solid sodium acetate were placed in a 500 mL reaction vessel, and heated to 56° C. while stirring under nitrogen gas flow. 0.08 mL of the hydrosilation catalyst was added, and the reaction was carried out at 60 to 80° C. for 6 hours. As a result, the reaction was almost completed. Thereby, a translucent liquid polyether-polysiloxane block copolymer composition “1528 mm²/s, (25° C.) including the straight chain organopolysiloxane-polyether block copolymer at least containing a structural unit expressed by the average composition formula:

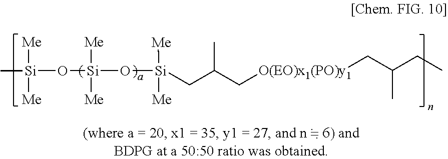

The molar ratio of C═C groups and Si—H groups in the raw materials C═C/SiH was approximately 1.10, and therefore, both terminals of the copolymer have a form blocked by a polyether (=terminal functional group is a methallyl group or hydroxyl group bonded to a polyether). Furthermore, a portion of the Si—H groups in the reaction can cause a dehydrogenative condensation reaction with a hydroxyl group of the BDPG, and therefore, a portion of the copolymer terminal is considered to include a structure of SiO-iPr or SiO-R¹ (R¹ represents a BDPG residual group or the like). Note that herein, a polyether portion is a random adduct of ethylene oxide and propylene oxide.

### Reference Example 1

A 500 mL reaction vessel was charged with 104.19 g of (a1-3) bismethallylpolyether (containing 500 ppm of natural vitamin E) and 0.15 g of 5 wt. % sodium acetate in MeOH, and heating was started while stirring under nitrogen gas flow. MeOH was removed out of the system by a stripping operation for 30 minutes under the conditions of 60 to 80° C. and 2 mmHg. The pressure was restored, 45.81 g of (a1-1) methylhydrogenpolysiloxane and 150 g of (B′) BDPG (Company L) were added under stirring, and 0.08 mL of hydrosilation catalysts were further added, and the reaction was carried out at 60 to 80° C. for 5 hours, with the result that the reaction was substantially complete. Thereby, an essentially clear liquid polyether-polysiloxane block copolymer composition “1619 mm²/s, (25° C.) including the straight chain organopolysiloxane-polyether block copolymer at least containing a structural unit expressed by the average composition formula:

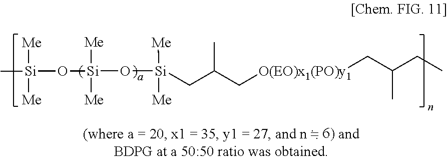

The molar ratio of C═C groups and Si—H groups in the raw materials C═C/SiH was approximately 1.10, and therefore, both terminals of the copolymer have a form blocked by a polyether (=terminal functional group is a methallyl group or hydroxyl group bonded to a polyether). Furthermore, a portion of the Si-H groups in the reaction can cause a dehydrogenative condensation reaction with a hydroxyl group of the BDPG, and therefore, a portion of the copolymer terminal is considered to include a structure of SiO-iPr or SiO-R¹ (R¹ represents a BDPG residual group or the like). Note that herein, a polyether portion is a random adduct of ethylene oxide and propylene oxide. The same applies to Reference Examples 2 and 3 described below.

### Reference Example 2

A 500 mL reaction vessel was charged with 86.19 g of (a1-1) bismethallylpolyether (containing 500 ppm of natural vitamin E) and 0.12 to 0.13 g of 5 wt. % sodium acetate in MeOH, and heating was started while stirring under nitrogen gas flow. MeOH was removed out of the system by a stripping operation for 40 minutes under the conditions of 60 to 80° C. and 1 to 3 mmHg. e was restored, 38.81 g of (a1-1) methylhydrogenpolysiloxane and 125 g of (B′) BDPG (Company L) were added under stirring, and 0.06 mL of hydrosilation catalysts were further added, and the reaction was carried out at 60 to 90° C. for 6 hours, with the result that the reaction was substantially complete. Thereby, an essentially clear liquid polyether-polysiloxane block copolymer composition “1714 mm²/s, (25° C.) including the straight chain organopolysiloxane-polyether block copolymer at least containing a structural unit expressed by the average composition formula:

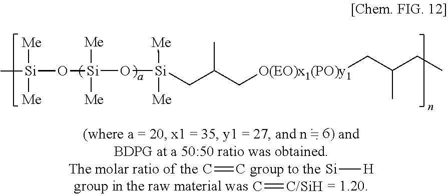

Herein, Reference Example 2 is a reproduction test of Reference Example 1 for the case of changing the lots of bismethallylpolyether, but is different from the test where the total amount of the main raw material was 250 g as compared to 300 g in Reference Example 1. Furthermore, the C═C/SiH molar ratio was changed from 1.10 in Reference Example 1 to 1.20 so that the viscosity of the copolymer composition fell within the target range in consideration of the difference in the methallyl blocking rate (determined by the residual hydroxyl value) and the degree of unsaturation (a measure of the average molecular weight) derived from a difference in the production lot of the bismethallylpolyether. Manipulation of these preparation conditions and the use of buffering agent solutions (5 wt. % sodium acetate in MeOH) provides relatively good reproducibility.

### Comparative Example 3-1

A test was performed in the same manner as in Example 1-1 except that 0.03 g of a 3 wt. % PG solution of potassium acetate (6 wt. ppm as potassium acetate relative to BDPG) was used in place of the (K+S) 0.30 g of a 3 wt. % PG solution of potassium acetate to obtain a light yellowish brown essentially clear liquid composition of polyether-polysiloxane block copolymer “1501 mm²/s, (25° C.)”.

### Comparative Example 3-2

A test was performed in the same manner as in Example 1-1 except that 0.30 g of a 2.5 wt. % PG solution of sodium acetate (50 wt. ppm as sodium acetate relative to BDPG) was used in place of the (K+S) 0.30 g of a 3 wt. % PG solution of potassium acetate to obtain a light yellowish brown essentially clear liquid composition of polyether-polysiloxane block copolymer “1639 mm²/s, (25° C.)”.

### Summary

The compositions of Examples 1-1 to 1-4 used a certain amount of a specific soluble potassium salt (component (K)) and used BDPG manufactured by Company L which is relatively inexpensive and has a slightly higher acid value as a raw material. Although the viscosity of the compositions was slightly lower than those of Comparative Example 1, Reference Example 2, and the like, it was confirmed that the compositions had excellent transparency (for example, light transmittance T %) and remarkably excellent foaming (in other words, foam enhancing effect due to surfactant ability) as compared with the test examples. In general, with respect to a composition containing the “specific polyether-polysiloxane block copolymer (A′)” as a main component, it has been conventionally said that if the molecular weight or degree of polymerization of component (A′) (viscosity of the composition) is not high, the foam retention capacity required for a foam stabilizer for mechanical froth foams will be insufficient. Therefore, with the present invention, it is expected that a composition having practically sufficient foam stability and transparency can be realized without strictly controlling the viscosity of the polyether-polysiloxane block copolymer in the synthesis reaction or after completion of the reaction, and thus a high-performance and inexpensive silicone foam stabilizer can be efficiently and easily produced.

The results are shown in Table 2.

TABLE 2

| | | | | | Buffering | | | Buffering agent name | | |
|---|---|---|---|---|---|---|---|---|---|---|
| | | | | T | agent | K* | C═C/ | and supplementary | | |
| Test No. | Viscosity | Foaming | n | % | [ppm] | [ppm] | SiH | information | BDPG | (a1) |
| Example 1-1 | 1505 | Excellent | 6 | 95 | 60 | 24 | 1.20 | CH₃CO₂K, 3%/PG | Company L | a1-1 |
| Example 1-2 | 1370 | Good | <6 | 88 | 67 | 27 | 1.20 | CH₃CO₂K, 50%/H₂O | Company L | a1-1 |
| Example 1-3 | 1529 | Excellent | 6 | 95 | 120 | 48 | 1.20 | CH₃CO₂K, 3%/PG | Company L | a1-1 |
| Example 1-4 | 1450 | Excellent | <6 | 93 | 60 | 24 | 1.20 | CH₃CO₂K, 30%/PG | Company L | a1-1 |
| Comparative | 1680 | — | 6 | 83 | 0 | — | 1.18 | — | Company H | a1-2 |
| Example 1 | | | | | | | | | | |
| Comparative | 931 | — | <6 | 40 | 0 | — | 1.10 | — | Company L | a1-3 |
| Example 2-1 | | | | | | | | | | |
| Comparative | 1528 | — | 6 | 63 | 60 | 17 (Na) | 1.10 | CH₃CO₂Na | Company L | a1-3 |
| Example 2-2 | | | | | | | | (Solid addition) | | |
| Reference | 1619 | — | 6 | 76 | 50 | 14 (Na) | 1.10 | CH₃CO₂Na | Company L | a1-3 |
| Example 1 | | | | | | | | (Finely Dispersed State) | | |
| Reference | 1714 | Small | 6 | 78 | 50 | 14 (Na) | 1.20 | CH₃CO₂Na | Company L | a1-1 |
| Example 2 | | | | | | | | (Finely Dispersed State) | | |
| Comparative | 1501 | Small | 6 | 78 | 6 | 2.4 | 1.20 | CH₃CO₂K, 3%/PG | Company L | a1-1 |
| Example 3-1 | | | | | | | | | | |
| Comparative | 1639 | Small | 6 | 76 | 50 | 14 (Na) | 1.20 | CH₃CO₂Na, 2.5%/PG | Company L | a1-1 |
| Example 3-2 | | | | | | | | | | |

*Ions other than potassium are expressed as “(Na)”. The same applies hereinafter.

On the other hand, Comparative Example 1 does not contain a buffering agent or component (K), and generally corresponds to the contents of Reference Example 1-1 of WO 2016/166979 (Patent Document 6). By using BDPG manufactured by Company H, which has a low acid value, high purity, and is expensive, it is possible to obtain a composition having practical viscosity and appearance, including the molecular weight of the copolymer, but the light transmittance thereof was inferior to those of Examples 1-1 to 1-4. In addition, since BDPG manufactured by Company H is expensive, it is difficult to stably supply the present composition to the market at a low price.

On the other hand, in Comparative Example 2-1 in which BDPG manufactured by Company L, which is relatively inexpensive and has a slightly higher acid value, was used as a raw material, only an opaque composition having a low viscosity was obtained. Similarly, in Comparative Example 2-2, sodium acetate was added as a solid to the synthesis reaction system of the (AB)n type polyether-modified silicone according to the present invention with reference to the production methods of the examples of Patent Document 8 and Patent Document 11, as a buffering agent, but only a translucent composition was obtained.

In Reference Examples 1 and 2, compositions having practical viscosity and appearance were obtained by a production method using a buffering agent (sodium salt) using BDPG manufactured by Company L, which is relatively inexpensive and has a slightly higher acid value as a raw material. However, in the examples of the present application, although the viscosity was slightly lower than those of the Reference Examples, the transparency was high, and the foam-enhancing property/foam retention resulting from the surfactant ability was greatly superior to those of the Reference Examples. This is considered to be an effect based on the use of the specific potassium ion as component (K).

On the other hand, in Comparative Example 3-1 in which the amount of component (K) used was insufficient and in Comparative Example 3-2 in which sodium acetate was used instead of the potassium salt but the other production conditions were the same as those in the Examples, the transparency of the obtained composition was poor and the foam-enhancing property/foam retention could not be achieved.

### Reference Example 3, Examples 2-1 to 2-8, Comparative Examples 4-1 to 4-5

The results when different soluble potassium salts are used are shown below, based on the type and composition of the raw materials shown in Reference Example 3. Note that examples 2-1 to 2-8 are experimental examples using component (K) of the present application, and the reaction process includes both those based on Example 2-1 (2-2, 2-3) and those based on Reference Example 3 (2-4 to 2-8). The foaming evaluation criteria were the same as in Example 1-1 and the like, and the results are shown in Table 3. However, in Example 2-5 to Comparative Example 4-1, the sample had to be transferred and then washed before verification of foaming in the test, so the record of “foaming” in Table 3 was set as No data, and the foam retention test described below was performed.

### Reference Example 3

A 500 mL reaction vessel was charged with (a1-4) bismethallylpolyether (containing 500 ppm of natural vitamin E) and 0.12 to 0.13 g of 5 wt. % sodium acetate in MeOH, and heating was started while stirring under nitrogen gas flow. MeOH was removed out of the system by a stripping operation for 30 minutes under the conditions of 60 to 80° C. and 7 to 8 mmHg. After the pressure was restored, 38.31 g of (a2-1) methylhydrogenpolysiloxane and 125 g of (B′) BDPG (Company L) were added under stirring, and 0.06 mL of hydrosilation catalysts were further added, and the mixture was reacted at 70 to 80° C. for 3 hours. Thereby, an essentially clear liquid polyether-polysiloxane block copolymer composition “1634 mm²/s, (25° C.)” including the straight chain organopolysiloxane-polyether block copolymer at least containing a structural unit expressed by the average composition formula:

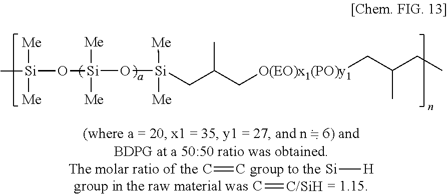

Reference Example 2 and Reference Example 3 were similar in that the total amount of the main raw materials was 250 g. The C═C/SiH molar ratio was changed from 1.20 in Reference Example 2 to 1.15 so that the viscosity of the copolymer composition fell within the target range in consideration of the difference in the methallyl blocking rate (determined by the residual hydroxyl value) and the degree of unsaturation (a measure of the average molecular weight) derived from a difference in the production lot of the polyether. However, the production process of Reference Example 2 and the effect of finely dispersing sodium acetate in the formulation (25 wt. ppm of the entire reaction system, 50 wt. ppm relative to BDPG) were considered to be satisfactorily reproduced in Reference Example 3, as can be seen from the viscosity and appearance of the copolymeric composition.

### Example 2-1

38.30 g of (a2-1) methylhydrogenpolysiloxane, 86.70 g of (a1-4) bismethallylpolyether (containing 500 ppm of natural vitamin E), 125 g of (B′) BDPG (Company L), and 0.25 g of 3% solution of potassium acetate in PG (60 wt. ppm as potassium acetate with regard to BDPG) were placed in a 500 mL reaction vessel, and then heated to 50° C. while stirring under a nitrogen gas flow. 0.03 mL of the hydrosilylation catalyst was added and aging was performed at 50 to 80° C. for 3 hours, whereupon the reaction was substantially complete. Thereby, a light yellow clear liquid polyether-polysiloxane block copolymer composition “1377 mm²/s, (25° C.)” including the straight chain organopolysiloxane-polyether block copolymer at least containing a structural unit expressed by the average composition formula:

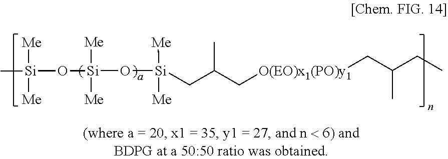

The molar ratio of C═C groups and Si—H groups in the raw materials C═C/SiH was approximately 1.15, and therefore, both terminals of the copolymer have a form blocked by a polyether (=terminal functional group is a methallyl group or hydroxyl group bonded to a polyether). Furthermore, a portion of the Si—H groups in the reaction is thought to cause a dehydrogenative condensation reaction with a hydroxyl group of the BDPG, and therefore, a portion of the copolymer terminal is considered to include a structure of SiO-iPr or SiO-R¹ (R¹ represents a BDPG residual group or the like). Note that herein, a polyether portion is a random adduct of ethylene oxide and propylene oxide.

### Example 2-2

A test was performed in the same manner as in Example 2-1 except that 0.28 g of a 3 wt. % PG solution of potassium propionate (68 wt. ppm as potassium propionate relative to BDPG) was used in place of the 0.30 g of a 3 wt. % PG solution of potassium acetate to obtain a light yellow clear liquid composition of polyether-polysiloxane block copolymer “1285 mm²/s, (25° C.)”.

### Example 2-3

A test was performed in the same manner as in Example 2-1 except that 0.15 g of a 5 wt. % MeOH solution of potassium acetate (60 wt. ppm as potassium acetate relative to BDPG) was used in place of the 0.30 g of a 3 wt. % PG solution of potassium acetate to obtain a light yellow clear liquid composition of polyether-polysiloxane block copolymer “1513 mm²/s, (25° C.)”.

### Example 2-4

A test was performed in the same manner as in Reference 3 except that 0.15 g of a 5 wt. % MeOH solution of potassium acetate (60 wt. ppm as potassium acetate relative to BDPG) was used in place of the 0.12 to 0.13 g of a 5 wt. % MeOH solution of sodium acetate to obtain a light yellow clear liquid composition of polyether-polysiloxane block copolymer “1527 mm²/s, (25° C.)”.

### Example 2-5

A test was performed in the same manner as in Reference 3 except that 0.16 g of a 5 wt. % MeOH solution of potassium propionate (68 wt. ppm as potassium propionate relative to BDPG) was used in place of the 0.12 to 0.13 g of a 5 wt. % MeOH solution of sodium acetate to obtain a light yellowish brown clear liquid composition of polyether-polysiloxane block copolymer “1515 mm²/s, (25° C.)”.

### Example 2-6

A test was conducted similar to Reference Example 3, except that 0.19 g of a MeOH solution of a 5 wt. % potassium isobutyrate (76 wt. ppm of potassium isobutyrate to BDPG) was used instead of 0.12 to 0.13 g of a MeOH solution of 5 wt. % sodium acetate. However, the amount of catalyst required was 0.09 mL. A light yellowish brown clear liquid polyether-polysiloxane block copolymer composition “1474 mm²/s, (25° C.)” was obtained.

### Example 2-7

A test was performed in the same manner as in Reference 3 except that 0.28 g of a 5 wt. % MeOH solution of potassium 2-ethylhexanoate (112 wt. ppm as potassium 2-ethylhexanoate relative to BDPG) was used in place of the 0.12 to 0.13 g of a 5 wt. % MeOH solution of sodium acetate to obtain a light yellowish brown clear liquid composition of polyether-polysiloxane block copolymer “1520 mm²/s, (25° C.)”.

### Example 2-8

A test was conducted similar to Reference Example 3, except that 0.15 g of an aqueous solution of a 5 wt. % potassium hydrogen carbonate (62 wt.ppm of a potassium hydrogen carbonate to BDPG) was used instead of 0.12 to 0.13 g of a MeOH solution of 5 wt. % sodium acetate. The reaction was slow and the consumption rate of SiH groups was only 99.3% even when 0.12 mL of catalyst was used. An orange clear liquid polyether-polysiloxane block copolymer composition “357 mm²/s, (25° C.)” was obtained. Despite having low viscosity, the composition exhibited excellent surfactant performance in the Foam Retention Test described below.

### Comparative Example 4-1

A test was performed in the same manner as in Reference 3 except that 0.38 g of a 5 wt. % MeOH solution of potassium laurate (152 wt. ppm as potassium laurate relative to BDPG) was used in place of the 0.12 to 0.13 g of a 5 wt. % MeOH solution of sodium acetate to obtain a light yellowish brown clear liquid composition of polyether-polysiloxane block copolymer “1407 mm²/s, (25° C.)”.

### Comparative Example 4-2

A test was conducted similar to Reference Example 3, except that 0.15 g of an aqueous solution of a 5 wt. % potassium carbonate (42 wt. ppm of a potassium carbonate to BDPG) was used instead of 0.12 to 0.13 g of a MeOH solution of 5 wt. % sodium acetate. However, the amount of catalyst required was 0.09 mL. A brown essentially clear liquid polyether-polysiloxane block copolymer composition “1508 mm²/s, (25° C.)” was obtained.

### Comparative Example 4-3

A test was performed in the same manner as in Reference 3 except that 0.25 g of a 5 wt. % aqueous solution of potassium benzoate (98 wt. ppm as potassium benzoate relative to BDPG) was used in place of the 0.12 to 0.13 g of a 5 wt. % MeOH solution of sodium acetate to obtain a light brown essentially clear liquid composition of polyether-polysiloxane block copolymer “1625 mm²/s, (25° C.)”.

### Comparative Example 4-4

A test was performed in the same manner as in Reference 3 except that 0.17 g of a 5 wt. % aqueous solution of tripotassium citrate monohydrate (66 wt. ppm as tripotassium citrate relative to BDPG) was used in place of the 0.12 to 0.13 g of a 5 wt. % MeOH solution of sodium acetate to obtain a brown opaque liquid composition of polyether-polysiloxane block copolymer “1062 mm²/s, (25° C.)”.

### Comparative Example 4-5

A test was conducted similar to Reference Example 3, except that 0.15 g of an aqueous solution of a 5 wt. % potassium lactate (78 wt. ppm of a potassium lactate to BDPG) was used instead of 0.12 to 0.13 g of a MeOH solution of 5 wt. % sodium acetate. However, the amount of catalyst required was 0.09 mL. A brown translucent liquid polyether-polysiloxane block copolymer composition “1634 mm²/s, (25° C.)” was obtained. On the next day after the completion of the reaction, the foam on the liquid surface had almost disappeared.

TABLE 3

| | | | | | Buffering | | | Buffering agent name | |
|---|---|---|---|---|---|---|---|---|---|
| | | | | T | agent | K* | C═C/ | and supplementary | |
| Test No. | Viscosity | Foaming | n | % | [ppm] | [ppm] | SiH | information | BDPG |
| Reference | 1634 | Small | 6 | 76 | 50 | 14 (Na) | 1.15 | CH₃CO₂Na | Company L |
| Example 3 | | | | | | | | (Finely Dispersed State) | |
| Example 2-1 | 1377 | Good | <6 | 92 | 60 | 24 | Same as | CH₃CO₂K, 3%/PG | Company L |
| | | | | | | | above | | |
| Example 2-2 | 1285 | Good | <6 | 92 | 67 | 23 | Same as | C₂H₅CO₂K, 3%/PG | Company L |
| | | | | | | | above | | |
| Example 2-3 | 1513 | Excellent | 6 | 96 | 60 | 24 | Same as | CH₃CO₂K, 5%/MeOH | Company L |
| | | | | | | | above | | |
| Example 2-4 | 1527 | Excellent | 6 | 96 | 60 | 24 | Same as | CH₃CO₂K | Company L |
| | | | | | | | above | (Dissolved in System) | |
| Example 2-5 | 1515 | No data | 6 | 94 | 64 | 22 | Same as | C₂H₅CO₂K | Company L |
| | | | | | | | above | (Dissolved in System) | |
| Example 2-6 | 1474 | No data | <6 | 85 | 76 | 24 | Same as | i-C₃H₇CO₂K | Company L |
| | | | | | | | above | (Dissolved in System) | |
| Example 2-7 | 1520 | No data | 6 | 93 | 112 | 24 | Same as | C₄H₉CH(C₂H₅)CO₂K | Company L |
| | | | | | | | above | (Dissolved in System) | |
| Example 2-8 | 357 | No data | <6 | 87 | 60 | 23 | Same as | KHCO₃ | Company L |
| | | | | | | | above | (Dissolved in System) | |
| Comparative | 1407 | No data | <6 | 86 | 152 | 25 | Same as | C₁₁H₂₃CO₂K | Company L |
| Example 4-1 | | | | | | | above | (Dissolved in System) | |
| Comparative | 1508 | Small | 6 | 77 | 40 | 23 | Same as | K₂CO₃ | Company L |
| Example 4-2 | | | | | | | above | (Finely Dispersed State) | |
| Comparative | 1625 | Small | 6 | 88 | 100 | 24 | Same as | Ph—CO₂K | Company L |
| Example 4-3 | | | | | | | above | (Finely Dispersed State) | |
| Comparative | 1062 | Small | <6 | 41 | 68 | 25 | Same as | Tripotassium citrate | Company L |
| Example 4-4 | | | | | | | above | (Finely Dispersed State) | |
| Comparative | 1634 | Small | 6 | 64 | 80 | 24 | Same as | CH₃CH(OH)CO₂K | Company L |
| Example 4-5 | | | | | | | above | (Finely Dispersed State) | |

*Ions other than potassium are expressed as “(Na)”. The same applies hereinafter.

### Summary

As a result of evaluating various formulations of potassium salts having different structures, Examples 2-1 to 2-8 in which a soluble potassium salt corresponding to component (K) of the present application was used were able to provide a composition having excellent transparency. From the results of foaming during the test and the foam retention test described below, these compositions were confirmed to have excellent foam-enhancing properties as a foam stabilizer. On the other hand, in Reference Example 3 and Comparative Examples 4-1 to 4-5, the transparency (light transmittance) of the composition was insufficient, and the foam-enhancing property could not be confirmed.

### Example 3 and Comparative Example 5

In the following test, compositions containing a polyether-polysiloxane block copolymer (A′) having a high degree of polymerization were prepared under various different conditions of “no buffering agent” vs. “component (K): potassium acetate” using a design in which the production lot numbers of the main materials (polyether, polysiloxane, BDPG) were fixed to be the same as those in Reference Example 3 and Examples 2 to 4 and the C═C/SiH molar ratio was close to 1.0. The results are shown in Table 4.

### Example 3

A 500 mL reaction vessel was charged with 81.45 g of (a1-4) bismethallylpolyether (containing 500 ppm of natural vitamin E) and 0.15 g of (K+S) 5 wt. % potassium acetate in MeOH, and heating was started while stirring under nitrogen gas flow. MeOH was removed out of the system by a stripping operation for 1 hour under the conditions of 55 to 70° C. and 3 to 4 mmHg. The pressure was restored, 43.57 g of (a2-1) methylhydrogenpolysiloxane and 125 g of (B′) BDPG (Company L) were added under stirring, and 0.09 mL of hydrosilation catalysts were further added, and the reaction was carried out at 40 to 80° C. for 5.5 hours, with the result that the reaction was substantially complete. Thereby, a light orange clear viscose liquid polyether-polysiloxane block copolymer composition “29600 cP, (25° C.) including the straight chain organopolysiloxane-polyether block copolymer at least containing a structural unit expressed by the average composition formula:

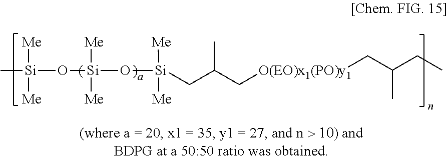

### Comparative Example 5

43.56 g of (a1-1) methylhydrogenpolysiloxane, 81.45 g of (a2-4) bismethallylpolyether (containing 500 ppm of natural vitamin E), and 125 g of (B′) BDPG (Company L) were placed in a 500 mL reaction vessel, and heated to 45° C. with stirring under a stream of nitrogen. 0.06 mL of a ligand solution of 1,3-divinyl-1,1,3,3-tetramethyldisiloxane platinum complex (Pt concentration 0.43 wt %) was added, and the reaction was conducted at 45-80° C. for 4.5 hours, resulting in a nearly complete reaction. Thereby, a brown essentially clear liquid polyether-polysiloxane block copolymer composition “7300 cP, (25° C.) including the straight chain organopolysiloxane-polyether block copolymer at least containing a structural unit expressed by the average composition formula:

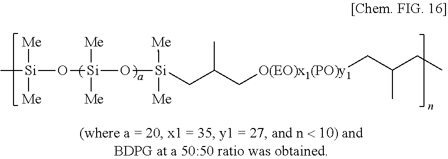

TABLE 4

| | | | | | | | | Buffering agent | |
|---|---|---|---|---|---|---|---|---|---|
| | | | | | Buffering | | | name and | |
| | Viscosity | | | | agent | K | C═C/ | supplementary | |
| Test No. | [cP] | Foaming | n | T % | [ppm] | [ppm] | SiH | information | BDPG |
| Example 3 | 29600 | Excellent | >10 | 89 | 60 | 24 | 0.95 | CH₃CO₂K | Company |
| | | | | | | | | (Dissolved | L |
| | | | | | | | | in System) | |
| Comparative | 7300 | Small | <10 | 77 | 0 | 0 | 0.95 | Absent | Absent |
| Example 5 | | | | | | | | | |

### Summary

By setting the true value of the molar ratio of C═C groups to Si—H groups: C═C/SiH of the raw materials to a condition that would be close to 1.0 (0.95 if simply calculated from the analysis results of each raw material), a high molecular weight and high viscosity (AB)n type polyether-modified silicone composition could be obtained as shown in Comparative Example 5 (no buffering agent) even if BDPG manufactured by Company L, which is relatively inexpensive and has a slightly higher acid value, was used as the raw material. However, as shown in Example 3, it was confirmed that a (AB)n type polyether-modified silicone composition having even higher molecular weight and higher viscosity than Comparative Example 5 could be obtained by adding the potassium acetate buffering agent (K) of the present invention to the raw material system and then starting the synthesis reaction, and furthermore the composition had excellent foam-enhancing properties.

### GPC Analysis Results

GPC (detector: refractometer) analysis using a chloroform eluent was performed on the following four samples as representative samples of the compositions of the present invention. The results are shown in Table 5.

TABLE 5

| | | | | Peak Area |
|---|---|---|---|---|
| | | | | Ratio % |
| | | | Number | of Unreacted |
| | Designed | Peak | average | Methallyl |
| | degree of | Number, | molecular | Polyether |
| | polymer- | Shape of | weight of | With Regard to |
| Test No. | ization n | Copolymer | copolymer | Copolymer |
| Reference | 6 | One peak | 37,900 | 11.0 |
| Example 3 | | | | |
| Example 2-4 | 6 | One peak | 37,400 | 11.6 |
| Example 3 | >10 | One peak | 76,600 | 2.6 |
| Comparative | >10 | One peak | 57,400 | 3.8 |
| Example 5 | | | | |

On the other hand, when BPDG and GPC having a secondary hydroxyl group were used as the reaction solvent, a copolymer with a molecular weight exceeding 30,000, used as a measure for exhibiting performance as a foam stabilizer for polyurethane microcellular foam, was obtained, and the ratio of unreacted and remaining polyethers containing a methallyl group on both terminals was low. However, when Comparative Example 5 synthesized without using component (K) and a buffering agent was compared with Example 3, although the designed degree of polymerization was n>10, the number average molecular weight as determined by GPC of the copolymer actually obtained in Comparative Example 5 was a smaller value, and a large amount of unreacted polyether raw material remained as compared with Example 3.

### Further Performance Evaluation as Foam Stabilizer

Although the above-mentioned evaluation based on “foaming” makes it possible to clearly distinguish between a sample composition that foams very well and a sample composition that foams little, the evaluation lacks precision for evaluating an intermediate product or a fine difference between samples having similar performances. Therefore, a “foam retention test” using a homodispering mixer to be described later was used to evaluate the performance of the compositions of the Examples and the like in greater detail.

### Preparation of Reference Examples 4-1 to 4-3 (Filtered Product)

Prior to the foam retention test, the filtered products of Reference Examples 1 to 3 were prepared by the following procedure in order to be used as an evaluation standard or a standard after addition of component (K) described below.

### Reference Example 4-1: Filtered Product of Reference Example 2

The polyether-polysiloxane block-copolymer composition 100 g obtained in Reference Example 2 was filtered through a zeta-potential-type adsorption filter having a diameter of 90 mm to obtain 80.3 g of a light yellow clear uniform filtered liquid. Thus, the light transmittance T % (580 nm) of the composition was improved from 78% before filtration to 97% after filtration.

### Reference Example 4-2: Filtered Product of Reference Example 3

The polyether-polysiloxane block-copolymer composition 100.1 g obtained in Reference Example 3 was filtered through a zeta-potential-type adsorption filter having a diameter of 90 mm to obtain 80.8 g of a pale yellow transparent filtrate. Thus, the light transmittance T % (580 nm) of the composition was improved from 79% before filtration to 97% after filtration.

### Reference Example 4-3: Mixed Solution of Filtered Product of Reference Example

Reference Example 1 (180 g), Reference Example 2 (66 g), and Reference Example 3 (115 g) were filtered through a zeta-potential adsorption filter having a pore size of 90 mm, and the resulting filtrates were further mixed with Reference Example 4-1 (35 g) and Reference Example 4-2 (47 g) to obtain polyether-polysiloxane block-copolymer-containing compositions 423 g as a slightly yellow clear liquid.

### Test of Foam Retention

A plurality of samples of the above-mentioned Reference Examples, Examples and Comparative Examples were tested for foam retention as a surfactant by the following procedure using a homodispering mixer. In order to increase the stirring force, the direction of the blade of the disperser was fixed to be opposite to the direction of rotation.

### Preparation Procedures

1. The foam stabilizer sample 30 g is placed in a clean 200 mL wide-mouthed glass bottle and allowed to stand.
2. The height of the liquid level of the sample was measured and recorded. A line is drawn along the meniscus using an oil-based permanent marker, and the height of the upper edge of the line is considered to be the initial height of the liquid surface. Generally, the lower edge of the line is located 18 mm from the bottom of the bottle and the upper edge of the stopper is located 20 mm from the bottom of the bottle.
3. The blade of the homodispering mixer is immersed in the central part of the liquid, and the height is set at a slightly higher position such that the blade does not touch the bottom of the glass bottle.
4. The glass bottle that contained the sample is cleaned.
5. Stirring is performed for 2 minutes at 3000 rpm using the homodispering mixer.
6. When the stirring is stopped, the blade is moved to a higher position of about 1 cm so as not contact the foamed liquid and fixed in place, and is dry spun for a short time to remove the liquid adhering to the blade.
7. The glass bottle is removed, the foam height (top) is marked with an oil-based permanent marker, and the difference [cm] from the initial height is determined. The foam retention is determined to be good or bad based on the magnitude of this numerical value.
   Note) Procedures 6 and 7 were performed in a short time of approximately 30 seconds. However, it was found by observation after the test that the height of the generated foam had almost no change in approximately 3 to 5 minutes.
   Table 6 below summarizes the physical properties and foam retention test results for each composition.
   Note that the amount of potassium added in the table is in ppm by weight based on BDPG. In a series of evaluations in Table 6, Reference Example 4-2 was treated as a reference product for foam retention performance.

### Table 6: Relationship Between Sample Content and Foam Retention, Buffering Agent System, and the Like

TABLE 6

| | | | Foam volume | | | |
|---|---|---|---|---|---|---|
| | | Foam | increase ratio | | | |
| | | height | [%] vs. | Included buffering agent | K * | Transparency of |
| Test No. | Viscosity | [mm] | reference | system | [ppm] | foam stabilizer |
| Reference | 1714 | +3 | −29 | CH₃CO₂Na (unfiltered) | 14(Na) | Nearly clear |
| Example 2 | | | | | | |
| Reference | 1714 | +5 | +18 | CH₃CO₂Na (filtered) | 1.1 (Na) | Clear |
| Example 4-1 | | | | | | |
| Reference | 1634 | +4 to 4.5 | 0 | CH₃CO₂Na (filtered) | Same as | Clear |
| Example 4-2 | | | | | above | |
| (Standard) | | | | | | |
| Example 1-1 | 1505 | +7 | +65 | CH₃CO₂K/PG | 24 | Clear |
| Example 1-2 | 1370 | +6.5 | +53 | CH₃CO₂K/H₂O | 24 | Clear |
| Example 1-3 | 1529 | +8 | +88 | CH₃CO₂K/PG | 48 | Clear |
| Example 1-4 | 1450 | +7.5 | +76 | CH₃CO₂K/PG | 24 | Clear |
| Example 2-1 | 1377 | +6.5-7 | +59 | CH₃CO₂K/PG | 24 | Clear |
| Example 2-2 | 1285 | +7.5-8 | +82 | C₂H₅CO₂K/PG | 24 | Clear |
| Example 2-3 | 1513 | +7 | +65 | CH₃CO₂K/MeOH | 24 | Clear |
| Example 2-4 | 1527 | +8.5 | +100 | CH₃CO₂K | 24 | Clear |
| Example 2-5 | 1515 | +7 | +65 | C₂H₅CO₂K | 24 | Clear |
| Example 2-6 | 1474 | +6.5-7 | +59 | i-C₃H₇CO₂K | 24 | Clear |
| Example 2-7 | 1520 | +5.5 | +29 | C₄H₉CH(C₂H₅)CO₂K | 24 | Clear |
| Example 2-8 | 357 | +14 | +230 | KHCO₃ | 24 | Clear |
| Comparative | 1501 | +2 | −53 | CH₃CO₂K/PG | 2.4 | Nearly clear |
| Example 3-1 | | | | | | |
| Comparative | 1407 | +3-3.5 | −24 | C₁₁H₂₃CO₂K | 24 | Clear |
| Example 4-1 | | | | | | |
| Comparative | 1508 | +1.5-2 | −59 | K₂CO₃ | 24 | Nearly clear |
| Example 4-2 | | | | | | |
| Comparative | 1625 | +2.5 | −41 | Ph—CO₂K | 24 | Nearly clear |
| Example 4-3 | | | | | | |
| Comparative | 1062 | +1-2 | −65 | K₃-citrate | 24 | Opaque |
| Example 4-4 | | | | | | |
| Comparative | 1634 | +2.5 | −41 | CH₃CH(OH)CO₂K | 24 | Translucent |
| Example 4-5 | | | | | | |

* Ions other than potassium are expressed as “(Na)”. The same applies hereinafter.
Note that Na [ppm] in Reference Example 4-1 is a quantitative value obtained by the “acid decomposition-ICPMS method”.

From Table 6, it was confirmed that the compositions containing KHCO₃ and potassium monovalent carboxylate having a hydrocarbon group with less steric hindrance as component (K) have good compatibility with the other components, and have excellent foam-enhancing effect. On the other hand, when the amount of potassium salt used was insufficient (Comparative Example 3-1) or when a potassium salt having an anion with a long-chain alkyl group, an anion having an aromatic ring, or a polyvalent anion (Comparative Examples 4-1 to 5) was used, a sufficient foam-enhancing effect could not be achieved. Note that Reference Examples 4-1 and 4-2 had the salts that were insoluble in the composition system removed by filtration and were samples having a practical level of foam stabilizing performance, but the compositions of the examples exhibited more excellent foam retention and surfactant effect than those of the reference samples.

Note that as described above, the foam-enhancing effect according to the present invention is a unique and remarkable effect that is exhibited only by a combination of component (A′) and component (B′) in a specific mass ratio, and where a specific potassium salt is used in a specific mass range. Therefore, the same effect will not be observed if an unspecified buffering agent is used in the hydrosilylation reaction of component (A′) or the like.

### Example 4, Example 5, Comparative Example 6, Reference Example 5: Evaluation of Premix Solution

6.0 g samples of Reference Example 4-1, Example 2-4, Example 3, and Comparative Example 5 were mixed with 24.0 g of polypropylene glycol (average molecular weight 425, abbreviation: PPG—425), which is a type of polyetherpolyol, to prepare premix solutions. At this time, the concentration of polyether-polysiloxane block copolymer (A′) in the solution was 10 wt. %. These are referred to as Reference Example 5, Example 4, Example 5, and Comparative Example 6, respectively.

The premix solutions were tested for foam retention according to the Foam Retention Test and Procedures described above. At this time, PPG—425 (30 g) without foam stabilizer was also tested as a reference sample. The results are summarized in the following Table 7. The foam volume increase rate [%] in the table was calculated based on the data of Comparative Example 5 (as 0).

### [Table 7]: Foam Retention of Premix Solution

TABLE 7

| | | | Foam | | |
|---|---|---|---|---|---|
| | | | volume | Foam | |
| | | Foam | increase | stabilizer | K [ppm] |
| | Pre-mix | retention | ratio | (Viscosity | Foam |
| Test No. | appearance | [mm] | [%] | @ 25 C.) | stabilizer |
| Comparison | Almost clear | +5.0 | (±0) | Comparative | 0 |
| Example 6: | to translucent | | | Example 5 | No |
| Standard | homogeneous | | | (7300 cP) | additives |
| | liquid | | | | |
| Reference | Clear | +16.5 | +230 | Reference | 1.1 (Na) |
| Example 5 | homogeneous | | | Example 4-1 | |
| | liquid | | | (1714 mm²/s) | |
| Example 4 | Clear | +19.0 | +280 | Example 2-4 | 24 |
| | homogeneous | | | (1527 mm²/s) | |
| | liquid | | | | |
| Example 5 | Clear | +26.0 | +420 | Example 3 | 24 |
| | homogeneous | | | (29600 cP) | |
| | liquid | | | | |
| Reference | Clear | +0.5 | NA | Absent | NA |
| sample | homogeneous | | | | |
| | liquid | | | | |
| | (PPG alone) | | | | |

Comparative Example 6 is considered to be a premix capable of achieving practical foam retention. However, in the premix of Example 4 in which component (K) was used, although the viscosity of the composition was low, the foaming properties and foam retention were superior to those of Comparative Example 6 and Reference Example 5, and thus it could be confirmed that the foam-enhancing effect provided by the dissolved potassium cations could be sufficiently achieved even in the form of a premix. It should be noted that the premix (Example 5) containing component (A′) with the specific dissolved potassium cations and having a high molecular weight was able to achieve maximum and excellent foam retention performance.

### Examples 6-1 to 6-6: Post Addition of Component (K)

Samples (Examples 6-1 to 6-6) were prepared by appropriately mixing (variable) 5 wt. % of a potassium acetate-PG solution or 5 wt. % of a potassium hydrogen carbonate aqueous solution in a sample of 60 g of Reference Example 4-3. Next, the foam retention of these foam stabilizer compositions was tested in accordance with the [Foam retention test] and [Preparation procedures] described above, and the results are shown in Table 8. Here, the reference product was Reference Example 4-3 itself. It should be noted that the post-addition of component (K) corresponds to the second production method according to the present invention.

### Table 8: Foam Retention of Foam Stabilizer Compositions With Post-Addition of Specific Potassium Salts

TABLE 8

| | | Foam | | | |
|---|---|---|---|---|---|
| | | volume | | | |
| | | increase | | | Trans- |
| | Foam | ratio | Included | | parency |
| | height | [%] vs. | buffering | K | of foam |
| Sample No. | [mm] | reference | agent system | [ppm] | stabilizer |
| Reference | +4 | 0 | CH₃CO₂Na | NA | Clear |
| Example 4-3 | | | (filtered) | No | |
| (Criteria) | | | | additives | |
| Example 6-1 | +5 | +25 | CH₃CO₂K/PG | 6.6 | Clear |
| Example 6-2 | +4.5 | +13 | CH₃CO₂K/PG | 40 | Clear |
| Example 6-3 | +5 | +25 | CH₃CO₂K/PG | 120 | Clear |
| Example 6-4 | +5-5.5 | +31 | KHCO₃/H₂O | 3.6 | Clear |
| Example 6-5 | +4.5 | +13 | KHCO₃/H₂O | 79 | Nearly |
| | | | | | clear |
| Example 6-6 | +5 | +25 | KHCO₃/H₂O | 195 | Haze |

From the results shown in Table 8, it was confirmed that the addition of a specific potassium salt solution after the synthesis of component (A′) in the presence of component (B′) has a foam-enhancing effect of increasing foam retention of the foam stabilizer composition. However, the foam-enhancing effect was limited as compared with the case where the potassium salt solution is added to the raw material system before the start of the synthesis reaction of component (A′) (=first production method). Furthermore, in some samples, the clarity of the composition was reduced.

### Examples 7 to 9: Compositions Containing Component (C) and Compatibility Evaluation Thereof

In the following test, the sample of Example 2-3 (hereinafter referred to as “Ex sample” or “Ex”) and component (C) were mixed, and the compatibility was evaluated. Component (C) which has excellent compatibility with the Ex sample is considered to be suitable as a diluent or a base polyol of a premix liquid for polyurethane foam containing the composition of the present invention. It should be noted that as another effect of these diluents, the hydroxyl value of the foam stabilizer can be adjusted, thereby making it possible to control the influence on the pre-designed strength or crosslinking density of the polyurethane foam. Furthermore, this is effective for controlling the air permeability and cell size of the foam.

Herein, Examples 7 to 9 are ranked as follows.
Example 7: Compatibility evaluation test between Ex sample and polyethermonool (C1)
Example 8: Evaluation test of compatibility between Ex sample and polyetherdiol (C2)
Example 9: Evaluation test of compatibility between Ex sample and polyethertriol (C3)

### Compatibility Evaluation Test

A total of 10 g of the Ex sample and component (C) were introduced into a 25 mL screw pipe at three blending ratios of Ex/C=5.0 g/5.0 g, 2.0 g/8.0 g, and 0.5 g/9.5 g, and a compatibility test: visual confirmation of the liquid appearance was performed according to the following procedure.

### Procedures

1. The screw pipe was capped and shaken well up and down approximately 10 times, and then left to stand in a thermostatic bath at 50° C. for approximately 10 to 15 minutes to substantially eliminate air bubbles.
2. After recording the appearance at 50° C., the screw pipe was removed and allowed to return to room temperature.
3. After the appearance at room temperature was recorded, a sample whose appearance was cloudy and non-uniform was left to stand for one night for follow-up. A sample having a translucent to clear appearance but being visually uniform was left to stand in a refrigerator at 5° C. for 1 to 2 hours, and a change in appearance was observed.
4. The appearance of the sample in the refrigerator at 5° C. was recorded, then the screw pipe was removed and allowed to return to room temperature. In addition, an evaluation is performed as to whether the appearance at room temperature is significantly different from the appearance record (room temperature) of procedure 3.
5. The appearance of the cloudy sample in procedure 3 was recorded after standing for one night.
   It should be noted that the appearance evaluation was recorded according to the following criteria.
* An intermediate case between the two cases is indicated by “˜”.
[symbol] : Clear homogeneous liquid
O: Clear or nearly clear uniform liquid
Δ: Translucent homogeneous liquid
X: Opaque cloudy liquid
   Furthermore, if incompatibility occurs such that separation occurred (gumming up) overnight, that fact was described in the table.

### Example 7: Evaluation Test of Compatibility With Polyethermonool (C1)

Table 9 shows the results of evaluating the compatibility between the Ex sample and polyethermonool (C1) having the structures and molecular weights shown in Table 9 below.

TABLE 9

| <Example 7> | Ex/C1 = | Ex/C1 = | Ex/C1 = |
|---|---|---|---|
| C1 structure | 50/50 | 20/80 | 5/95 |
| Average molecular | (A′)/(B′)/C1 = | (A′)/(B′)/C1 = | (A′)/(B′)/C1 = |
| weight/EO wt.% | 25/25/50 | 10/10/80 | 2.5/2.5/95 |
| Example 7-1 | 50° C.: ⊚ | 50° C.: ⊚ | 50° C.: ⊚ |
| Bu—O(PO)_{4.5}—H | 20° C.: ⊚ | 20° C.: ⊚ | 20° C.: ⊚ |
| Mw: 340/0 | 5° C.: ⊚ | 5° C.: ⊚ | 5° C.: ⊚ |
| Example 7-2 | 50° C.: ⊚ | 50° C.: ⊚ | 50° C.: ⊚ |
| Bu—O(EO)_{4.8}(PO)_{3.7}—H | 20° C.: ⊚ | 20° C.: ⊚ | 20° C.: ⊚ |
| Mw: 500/50 | 5° C.: ⊚ | 5° C.: ⊚ | 5° C.: ⊚ |
| Example 7-3 | 50° C.: ⊚ | 50° C.: ⊚ | 50° C.: ⊚ |
| Bu—O(EO)_{10.5}(PO)_{8.0}—H | 20° C.: ⊚ | 20° C.: ⊚ | to ◯ |
| Mw: 1000/50 | 5° C.: ⊚ | 5° C.: ⊚ | 20° C. |
| | | | 5° C.: Δ |
| Example 7-4 | 50° C.: ⊚ | 50° C. | 50° C.: ⊚ |
| Bu—O(PO)₃₈—H | 20° C.: ⊚ | 20° C.: ◯ | to O |
| Mw: 2300/0 | 5° C. | to Δ | 20° C.: Δ |
| | | 5° C.: Δ | 5° C.: Δ |
| Example 7-5 | 20° C. | 20° C. | 20° C. |
| Bu—O(EO)₃₃(PO)₂₅—H | After 1 night: | After 1 night: | After 1 night: |
| Mw: 3000/50 | separation | separation | separation |
| | (gumming up) | (gumming up) | (gumming up) |
| Example 7-5 | 20° C. | 20° C. | 20° C. |
| Me—O(EO)_{8.4}—H | After 1 night: | After 1 night: | After 1 night: |
| Mw: 400/100 | separation | separation | separation |
| | (gumming up) | (gumming up) | (gumming up) |

Note that in the structure of C1 in Table 9, the EO chain and the PO chain are shown in block form for simplicity, but are actually random copolymers.

### Example 8: Evaluation Test of Compatibility With Polyetherdiol (C2)

Table 10 shows the results of evaluating the compatibility of the Ex samples with polyetherdiols (C2) having the structure and molecular weight shown below in Table 10.

TABLE 10

| <Example 8> | | | |
|---|---|---|---|
| C2 structure | Ex/C2 = 50/50 | Ex/C2 = 20/80 | Ex/C2 = 5/95 |
| Average molecular | (A′)/(B′)/C2 = | (A′)/(B′)/C2 = | (A′)/(B′)/C2 = |
| weight/EO wt. % | 25/25/50 | 10/10/80 | 2.5/2.5/95 |
| Example 8-1 | 50° C.: ⊚ | 50° C.: ⊚ | 50° C.: ⊚ |
| HO—(PO)₄—H | 20° C.: ⊚ | 20° C.: ⊚ | 20° C.: ⊚ |
| Mw: 250/0 | 5° C.: ⊚ | 5° C.: ⊚ | 5° C.: ⊚ to ◯ |
| Example 8-2 | 50° C.: ⊚ | 50° C.: ⊚ | 50° C.: ⊚ |
| HO—(PO)₃₄—H | 20° C.: ⊚ | 20° C.: ⊚ | 20° C.: ⊚ |
| Mw: 2000/0 | 5° C.: ⊚ | 5° C.: ⊚ to ◯ | 5° C.: ⊚ to ◯ |
| Example 8-3 | 50° C.: ⊚ | 50° C.: Δ | 50° C.: Δ |
| HO—(PO)₆₉—H | 20° C.: ⊚ | 20° C.: Δ | 20° C.: Δ |
| Mw: 4000/0 | 5° C.: ◯ to Δ | 5° C.: Δ to X | 5° C.: Δ |
| Example 8-4 | 20° C. | 20° C. | 20° C. |
| HO(EO)₂₀(PO)₁₅—H | After 1 night: | After 1 night: | After 1 night: |
| Mw: 1750/50 | separation | separation | separation |
| | (gumming up) | (gumming up) | (gumming up) |

Note)
Regarding the structure of C2 (Example 8-4) in Table 12, the EO chain and the PO chain are represented as block type for simplicity, but they are actually random copolymers.

### Example 9: Evaluation Test of Compatibility With Polyethertriol (C3)

Table 11 shows the results of evaluating the compatibility between the Ex samples and polyethertriols (C3) having the structures and molecular weights shown in Table 11 below.

TABLE 11

| <Example 9> | | | |
|---|---|---|---|
| C3 structure | Ex/C3 = 50/50 | Ex/C3 = 20/80 | Ex/C3 = 5/95 |
| Average molecular | (A′)/(B′)/C3 = | (A′)/(B′)/C3 = | (A′)/(B′)/C3 = |
| weight/EO wt. % | 25/25/50 | 10/10/80 | 2.5/2.5/95 |
| Example 9-1 | 50° C.: ⊚ | 50° C.: ⊚ | 50° C.: ⊚ to ◯ |
| Addition polymer of | 20° C.: ⊚ | 20° C.: ⊚ | 20° C. |
| PO alone with | 5° C.: ⊚ | 5° C.: Δ to X | 5° C.: Δ |
| glycerin | | | |
| Mw: 1000/0 | | | |
| Example 9-2 | 50° C.: ⊚ | 50° C.: ⊚ | 50° C.: ⊚ to ◯ |
| Addition polymer of | 20° C.: ⊚ | 20° C.: ◯ to Δ | 20° C.: ⊚ to ◯ |
| PO alone with | 5° C.: ⊚ | 5° C.: Δ | 5° C.: ◯ to Δ |
| glycerin | | | |
| Mw: 3000/0 | | | |
| Example 9-3 | 50° C.: ⊚ | 50° C.: Δ | 50° C. |
| Addition polymer of | 20° C.: ⊚ | 20° C.: Δ to X | 20° C.: ◯ to Δ |
| PO alone with | 5° C.: Δ | 5° C.: X | 5° C.: ◯ to Δ |
| glycerin | | | |
| Mw: 4000/0 | | | |
| Comparative | 20° C. | 20° C. | 20° C. |
| Example 9-1 | After 1 night: | After 1 night: | After 1 night: |
| EO/PO addition | separation | separation | separation |
| polymer of glycerin | (gumming up) | (gumming up) | (gumming up) |
| Mw: 2800/50 | | | |

Note)
The C3 structure (Comparative Example 9-1) in Table 13 is an EO/PO random co-polymer.

### Component (C1)

As shown in Table 9, when a polyether monool was used as a diluent, in the case of a single addition polymer of PO (propylene oxide), the compatibility with the component (A′) was maintained even when the number of moles added was close to 40 and the chain was long, and the stability of the mixed solution was good. On the other hand, in the case of an addition copolymer of EO (ethylene oxide) and PO, as a result of comparison at a constant EO wt. %=50 and a molecular weight of 500, 1000, 3000, the stability was extremely deteriorated in the last case where the total number of moles of EO added exceeded 30. Further, since the addition polymerization product of EO alone is not compatible with the component (A′) at all, it was also revealed that the polymerization unit of PO is necessary in the structure of the polyether monool.

From these results, it was estimated that when the polyether monool was used as a diluent, the upper limit of the number of moles of EO added was approximately 20, the upper limit of the number of moles of PO added was approximately 50, and the upper limit of the wt. % of EO in the structure was approximately 60. Furthermore, according to the experience of the present inventors, when the wt. % of EO in the polyether monool is 70 or more, the freezing point rises, and the polyether monool itself tends to cause precipitation or white turbidity in appearance at low temperatures in winter. Therefore, the upper limit of the wt. % of EO in the case of using the polyether monool as a diluent in the present invention was set to approximately 60.

### Component (C2)

As shown in Table 10, when polyether diol was used as a diluent, in the case of a single addition polymer of PO (propylene oxide), the compatibility with component (A′) was very good even if the number of moles added became a long chain of approximately 35, and the stability of the mixed liquid was also good. When the number of moles of PO added is around 70, a decrease in compatibility is observed. However, under conditions where the concentration of the component (A′) is high (Ex/C2=50/50), the mixture is stable within an allowable range, and it is considered that the mixture can be used as a foam stabilizer. On the other hand, as an addition copolymer of EO (ethylene oxide) and PO, one having EO wt. %=50 and a molecular weight of 1750 was tested, but it was found that the stability was extremely inferior.

From these results, it was estimated that when polyether diol is used as a diluent, the upper limit of the number of moles of EO added is around 10, the upper limit of the number of moles of PO added is around 70, and the upper limit of the wt. % of EO in the structure is around 30.

### Component (C3)

As shown in Table 10, the compatibility of polyethertriol with the composition according to the present invention tended to be slightly lower than that of polyetherdiol (C1) or polyethermonool (C2). In the case of polyethertriol which is a single addition polymer of PO, the compatibility was insufficient at a compounding ratio of Ex/C3=20/80, except for samples having a Mw of 3000. However, under conditions where the concentration of component (A′) is high (Ex/C3=50/50), the stability of the mixture is within an acceptable range, and it is considered that the mixture can be used as a foam stabilizer. In addition, even under the condition of Ex/C3=5/95 where the concentration of the component (A′) was low (assuming the situation of the premix liquid for polyurethane foam), the stability of the mixed liquid was within the allowable range. On the other hand, as an addition copolymer of EO (ethylene oxide) and PO, one having EO wt. %=50 and a molecular weight of 2800 was tested, but it was found that the stability was extremely inferior.

From these results, it was estimated that when the polyether triol was used as a diluent, the upper limit of wt. % of EO in the structure was around 20, and the range of the average molecular weight was approximately 500 to 4500.

### Summary

(A′) a polyether-polysiloxane block copolymer having a specific structure and (B′) a glycol ether compound in which the terminal hydrogen is substituted with a hydrocarbon group having 1 to 8 carbon atoms and the other terminal has a secondary alcoholic hydroxyl group and the number of repetitions of oxyalkylene units having 2 to 4 carbon atoms is in the range of 1 to 3 in a specific mass ratio, a polyether-polysiloxane block copolymer-containing composition having excellent transparency and achieving a specific foam-enhancing effect could be obtained by the aforementioned examples and the like. Similarly, the present inventors have found that a suitable combination of the composition according to the present invention and the component (C) and a compatibility relationship therebetween are sufficient for practical use.

In addition, the first production method or the second production method of the present invention can provide a polyether-polysiloxane block copolymer-containing composition having a practically sufficient performance as a foam stabilizer, even when an inexpensive component (B′) having a high acid value was used.

From the above test results, it is understood and expected that the present invention can provide a polyether-polysiloxane block copolymer composition which can solve the conventional problems of quality and process by a simple means and can be stably supplied to the market at a low cost in a large amount, an improved method for manufacturing the composition, the composition excellent in cost in use and foam-enhancing properties, and a foam stabilizer for polyurethane foams comprising the composition.

1. A composition, comprising:
(A′) a polyether-polysiloxane block copolymer having in a molecule constituent units expressed by general formula (1): 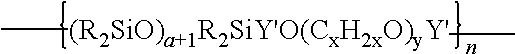
where each R independently represents a monovalent hydrocarbon group having 1 to 9 carbon atoms without an aliphatic unsaturated bond, x represents a number from 2 to 200, a represents a number from 1 to 4, y is a number in the range from 400 to 5000 and represents the molecular weight of the polyether portion expressed by (CₓH₂ₓO)_{y}, n represents a number that is at least 2, and Y′ represents a divalent hydrocarbon group having from 2 to 8 carbon atoms, which is bonded to a polyoxyalkylene block by a carbon-silicon bond by a silicon atom and an oxygen atom;
(B′) one or more type of glycol ether compound where a terminal hydrogen is substituted by a hydrocarbon group having 1 to 8 carbon atoms, a secondary alcoholic hydroxyl group is provided on another terminal, the repeating number of oxyalkylene units with 2 to 4 carbon atoms is a number within a range of 1 to 3, and heteroatoms other than oxygen are not included; and
(K) a potassium salt having a monovalent counter anion containing only carbon, hydrogen, and oxygen, having 1 to 8 carbon atoms, and not having a benzene ring structure;
where the mass ratio of components (A′):(B′) is in a range of 20:80 to 60:40, and the amount of potassium cation (K⁺) in component (K) is in a range of 3 to 300 wt. ppm, based on the sum of component (A′) and component (B′).

2. The composition according to claim 1, wherein in general formula (1), component (A′) is a polyether-polysiloxane block copolymer where a represents a number within a range of 10 to 45, y represents a number where the molecular weight of a polyether moiety as expressed by (CₓH₂ₓO)_{y} is within a range of 2000 to 5000, and the mass ratio of an oxyethylene (C₂H₄O) unit configuring the entire polyether moiety is within a range of 35 to 90% on average.

3. The composition according to claim 1, wherein in general formula (1), component (A′) is a polyether-polysiloxane block copolymer in which Y′ is a divalent hydrocarbon group having 3 to 4 carbon atoms.

4. The composition according to claim 1, wherein
component (A′) is a polyether-polysiloxane block copolymer having on a molecule terminal one or more type of functional group selected from:
Z¹: alkenyl groups, hydroxyl groups, alkoxy groups, or acetoxy groups bonded to a polyether portion; and
Z²: monovalent hydrocarbon groups that do not have a hetero atom, hydroxyl groups, alkoxy groups, a C1 to C8 hydrocarbon oxyalkylene group, or hydrogen atom, bonded to a silicon atom.

5. The composition according to claim 1, wherein component (B′) is one or two or more types of monool organic compound selected from propylene glycol monobutyl ethers, dipropylene glycol monobutyl ethers, tripropylene glycol monobutyl ethers, propylene glycol monomethyl ethers, dipropylene glycol monomethyl ethers, tripropylene glycol monomethyl ethers, propylene glycol mono(iso)propyl ethers, dipropylene glycol mono(iso)propyl ethers, tripropylene glycol mono(iso)propyl ethers, propylene glycol monoethyl ethers, dipropylene glycol monoethyl ethers, tripropylene glycol monoethyl ethers, 2-butyl-1-octanols, 2-hexyl-1-decanols, 2-octyl-1-dodecanols, isostearyl alcohols, and 2-decyl-1-tetradecanols.

6. The composition according to claim 1, wherein the monovalent counter anion of component (K) is a counter anion containing 1 to 4 carbon atoms, and the composition contains a potassium cation (K⁺) in component (K) in a range of 3 to 100 wt. ppm, based on the sum of components (A′) and (B′).

7. The composition according to claim 1, further comprising: (S) one or more liquid compounds, which are solvents of component (K), selected from (S1) water, (S2) a monohydric saturated alcohol having 1 to 4 carbon atoms, and (S3) a saturated diol compound having 3 to 9 carbon atoms, in a range of 20 to 15,000 wt. ppm, based on the sum of component (A′) and component (B′).

8. The composition according to claim 1, further comprising: (C) a polyether compound compatible with component (A′), component (B′) and component (K), selected from the following components (C1) to (C3):
(C1) a polyethermonool expressed by the following general formula (2) 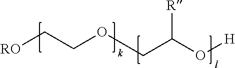
where R represents a monovalent hydrocarbon group having 1 to 9 carbon atoms and having no aliphatic unsaturated bonds, R″ represents a methyl group or an ethyl group, k satisfies the conditions of 0≤k≤20, l satisfies the conditions of 4≤l≤50, and the amount of the oxyethylene moiety in the polyether moiety is 60 wt. % or less;
(C2) a polyetherdiol expressed by the following general formula (3) 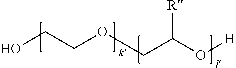
where R″ represents a methyl group or an ethyl group, k′ satisfies the conditions 0≤k′≤10, l′ satisfies the conditions 4≤l′≤70, and the weight% of oxyethylene moiety in the polyether moiety is 30 or less;
(C3) a polyethertriol containing 20 wt. % or less of an oxyethylene moiety and an average molecular weight in a range of 500 to 4500 and obtained by addition polymerization of an alkylene oxide having 2 to 4 carbon atoms to glycerin and/or trimethylolpropane.

9. A surfactant, foam stabilizer for polyurethane foam, or premix liquid for polyurethane foam, comprising: the composition according to claim 1.

10. A method of manufacturing the composition according to claim 1, the method comprising:
step (I):
a step of mixing
(a1) a polyether containing on both terminals an alkenyl group expressed by the following general formula (4):
Y—O(CₓH₂ₓO)_{y}—Y
where, x is a number of 2 to 4, y represents a number such that the molecular mass of the polyether moiety represented by (CₓH₂ₓO)_{y} is in the range of 400 to 5000, Y represents a monovalent hydrocarbon group having 2 to 8 carbon atoms and having a reactive C═C group at a terminal, and the polyether moiety contains at least one oxypropylene group, and
(K) a potassium salt having a monovalent counter anion containing only carbon, hydrogen, and oxygen, having 1 to 8 carbon atoms, and not having a benzene ring structure;
step (II):
performing a hydrosilylation reaction of the mixture obtained in step (I), and
(a2) an organopolysiloxane having an SiH group on both terminals, expressed by the following general formula (5): 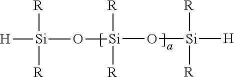
where, R is independently a monovalent hydrocarbon group having no aliphatic unsaturated bonds and having 1 to 9 carbon atoms, and a is a number from 1 to 200, in the presence of
(B′) one or more type of glycol ether compound where a terminal hydrogen is substituted by a hydrocarbon group having 1 to 8 carbon atoms, a secondary alcoholic hydroxyl group is provided on another terminal, the repeating number of oxyalkylene units with 2 to 4 carbon atoms is a number within a range of 1 to 3, and heteroatoms other than oxygen are not included; and
a hydrosilylation reaction catalyst;
however, the amount of potassium cation (K⁺) in component (K) relative to the sum of components (a1), (a2) and (B′) is in a range of 3 to 300 wt. ppm, and
the amount is such that the mass ratio between the sum of component (a1) and component (a2):component (B′) is 20:80 to 60:40.

11. The method for manufacturing the composition according to claim 10, further comprising:
a step of adding component (S) in step (I), where component (S) is one or more liquid compound that is a solvent for compound (K) selected from (S1) water, (S2) a monohydric alcohol having 1 to 4 carbon atoms, and (S3) a saturated diol compound having 3 to 9 carbon atoms, and mixing component (a1), component (K), and component (S); and
a step of removing component (S) outside of the reaction system by optional selection.

12. A method of manufacturing the composition according to claim 1, the method comprising:
step (I′)
a step of performing a hydrosilylation reaction of
(a1) a polyether containing an alkenyl group on both terminals expressed by the following general formula (4)
Y—O(CₓH₂ₓO)_{y}—Y
where x is a number of 2 to 4, y represents a number such that the molecular mass of the polyether moiety represented by (CₓH₂ₓO)_{y} is in the range of 400 to 5000, Y represents a monovalent hydrocarbon group having 2 to 8 carbon atoms and having a reactive C═C group at a terminal, and the polyether moiety contains at least one oxypropylene group, and
(a2) an organopolysiloxane having an SiH group on both terminals, expressed by the following general formula (5) 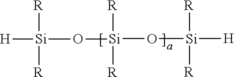
where, R individually represents a monovalent hydrocarbon group having no aliphatic unsaturated bonds and having from 1 to 9 carbon atoms, and a is a number from 1 to 200,
in the presence of
(B′) one or more type of glycol ether compound where a terminal hydrogen is substituted by a hydrocarbon group having 1 to 8 carbon atoms, a secondary alcoholic hydroxyl group is provided on another terminal, the repeating number of oxyalkylene units with 2 to 4 carbon atoms is a number within a range of 1 to 3, and heteroatoms other than oxygen are not included; and
a hydrosilylation reaction catalyst;
where the mass ratio of the sum of component (a1) and component (a2) to component (B′) is in the range of 20:80 to 60:40; and
step (II′)
a step of adding and mixing
the composition obtained from the hydrosilylation reaction of step (I′), and
(K) a potassium salt having a monovalent counter anion containing only carbon, hydrogen, and oxygen, having 1 to 8 carbon atoms, and not having a benzene ring structure;
however, the amount of potassium cation (K⁺) in component (K) relative to the sum of component (a1), component (a2) and component (B′) is in a range of 3 to 300 wt. ppm.

13. The method of manufacturing the composition according to claim 10, further comprising: a step of filtering the obtained composition after step (II).

14. The method of manufacturing the composition according to claim 10, further comprising: after step (II) a step of adding, mixing and homogenizing component (C) a polyether-containing compound compatible with the component (A′), component (B′) and component (K) and selected from the following components (C1) to (C3) to the obtained composition, however, the amount of the component (C) used is such that the amount of component (A′) in the finally obtained composition is 1% by weight or more;
(C1) a polyethermonool expressed by the following general formula (2) 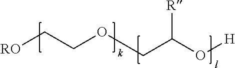
where R represents a monovalent hydrocarbon group having 1 to 9 carbon atoms and having no aliphatic unsaturated bonds, R″ represents a methyl group or an ethyl group, k satisfies the conditions of 0≤k≤20, l satisfies the conditions of 4≤l≤50, and the amount of the oxyethylene moiety in the polyether moiety is 60 wt. % or less;
(C2) a polyetherdiol expressed by the following general formula (3) 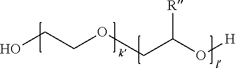
where R″ represents a methyl group or an ethyl group, k′ satisfies the conditions 0≤k′≤10, l′ satisfies the conditions 4≤l′≤70, and the weight % of oxyethylene moiety in the polyether moiety is 30 or less;
(C3) a polyethertriol containing 20 wt. % or less of an oxyethylene moiety and an average molecular weight in a range of 500 to 4500 and obtained by addition polymerization of an alkylene oxide having 2 to 4 carbon atoms to glycerin and/or trimethylolpropane.

15. A polyurethane foam-forming composition, comprising: the composition according to claim 1.

16. A method of manufacturing a surfactant, foam stabilizer for polyurethane foam, or premix liquid for polyurethane foam, comprising the method for producing the composition according to claim 10.

17. A polyurethane foam-forming composition, comprising: the composition obtained by the method for manufacturing the composition according to claim 10.

18. A polyurethane foam, comprising: as a raw material, the composition according to claim 1.
